(19) United States
(12) Patent Application Publication
(10) Pub. No.: US 2025/0122927 A1
(43) Pub. Date: Apr. 17, 2025

(54) THREADABLE CYCLOID ACTUATOR

(71) Applicant: Agility Robotics, Inc., Pittsburgh, PA (US)

(72) Inventor: Kevin Francis Sweeney, Albany, OR (US)

(21) Appl. No.: 18/479,022

(22) Filed: Sep. 30, 2023

Related U.S. Application Data
(60) Provisional application No. 63/515,489, filed on Jul. 25, 2023.

(51) Int. Cl. F16H 37/12; B62D 57/032

(52) U.S. Cl. CPC F16H 37/122; B62D 57/032

(57) ABSTRACT

Disclosed is a threadable cycloid actuator having a cycloid drive with a through-bore tube, designed for the purpose of operatively connecting links in a kinematic chain and absorbing high torque and shock-load. The cycloid drive has a hollow input-shaft that receives a connective element at a joint in the kinematic chain, where the element traverses the through-bore tube and operatively connects to a further joint in the kinematic chain.

### CROSS-REFERENCE TO RELATED APPLICATION

This claims the benefit of U.S. Provisional Application No. 63/515,489, filed Jul. 25, 2023. The foregoing application is incorporated herein by reference in its entirety. To the extent the foregoing application and/or any other material incorporated herein by reference conflicts with the present disclosure, the preset disclosure controls.

### TECHNICAL FIELD

The present technology relates to methods and systems for managing torque, shock-load, and communication and connectivity in a kinematic chain of an autonomous robot.

### BACKGROUND

Robot design and architecture is ever-evolving in order to maximize the efficiency and robustness of the robot. For example, robots require wires, cables, fluid lines, control lines, power lines, and communication lines to connect each link or limb in the kinematic chain to the next, via robot joints. Typically, these connecting elements are external to the robot architecture and are exposed and vulnerable to wear, entanglement, and impact, and have a contributory negative effect on the integrity and functional lifespan of useful working robots. Robot joints are also vulnerable. As a robot takes a step, impact forces experienced by the robot foot on contact with the ground, are transmitted along the length of the leg to the knee and other joints, wherein the forces are ultimately absorbed. Each joint in the robot contains at least one actuator for causing movement of the limb distal to the joint. In legged robots, the actuator located at the knee in particular, experiences high torque and shock-load.

Cycloid drives are designed to be robust to high shock-loads and large torques, and may provide a means of handling such forces, however the compact architecture of typical cycloid drives have restricted their use in robot designs that have attempted to solve the problem of external wiring in robot kinematic chains. Therefore, there is a need in the art for an actuator, particularly for use in robot joints, that is both threadable to allow the pass-through of cables and wiring from one link to the next, whilst also being capable of absorbing large forces.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

Disclosed herein is a cycloid drive assembly with a through-bore tube for the purpose of operatively connecting links in a kinematic serial chain. The cycloid drive assembly comprises a hollow input-shaft of a first diameter and a through-bore tube of a second diameter, wherein the through-bore tube is concentrically positioned within the hollow input-shaft. The through-bore tube receives a first element at a first joint in the kinematic serial chain, and the first element traverses the through-bore tube and operatively connects the first joint to a second joint in the kinematic serial chain. The input-shaft is also operatively coupled to receive torque from a motor. The cycloid drive also comprises: a roller bearing, wherein the roller bearing is eccentrically mounted to the input-shaft meaning the bearing is mounted off center to the axis of rotation of the input-shaft; a mid-ring, wherein the mid-ring comprises a set of mid-ring rollers; a cycloid-disc, comprising N external lobes, wherein the cycloid-disc is positioned onto the set of mid-ring rollers; and an outer-roller-ring, wherein the outer-roller-ring comprises N+1 outer-rollers, and wherein the outer-roller-ring of the drive has a reduced speed and an increased torque relative to the hollow input-shaft.

In some embodiments the cycloid drive may comprise more than one cycloid discs, wherein each cycloid-disc is out of phase relative to each other by 360° divided by the number of cycloid discs utilized in the drive. For example, in another embodiment, wherein the cycloid drive comprises two cycloid discs, each disc is out of phase with each other by 180°. In some further embodiments of the cycloid drive, the mid-ring is fixed to an input housing element and is stationary; and in still further embodiments, the mid-ring is fixed to an output-housing element and rotates at an output speed. In some embodiments the cycloid drive comprises more than one roller bearing, for example, the drive may comprise 1, 2, 3, 4, 5, 6, 7, 8, 9, or 10 or more roller bearings.

In some embodiments, the cycloid drive is operatively coupled to a first actuator. In other embodiments of the cycloid drive, the through-bore tube receives the first element from the first actuator, and operatively connects the first actuator to a second actuator. In further embodiments, the through-bore tube receives the first element from the first actuator, and operatively connects the first actuator to a passive joint. In some embodiments, the first joint comprises the first actuator, and the second joint comprises the second actuator. In further embodiments the first joint is one of a hip, knee, ankle, shoulder, wrist, or a finger joint, and in other embodiments the second joint is one of a hip, knee, ankle, shoulder, wrist, or a finger joint. In another embodiment the first actuator comprises a knee joint and the second actuator comprises an ankle joint, and wherein the first element comprising the through-bore tube operatively connects the knee joint to the angle joint of the kinematic serial chain.

In some embodiments of the cycloid drive the first element is at least one or more of: cable(s), wire(s), fluid line(s), control line(s), communication line(s) and power line(s), such that, for example an cable, a wire and a control line may be threaded through the cycloid drive.

In certain embodiments of the cycloid drive, the diameter of the through-bore tube is about 8-16 mm. In other embodiments, the input-shaft comprises one or more of aluminum, iron, stainless steel, 7075-T6 Aluminum, 6061-T6 Aluminum, 416 Stainless Steel, 17-4 Stainless Steel, and 4140 Alloy Steel. In further embodiments the through-bore tube comprises one or more of aluminum, iron, stainless steel, 7075-T6 Aluminum, 6061-T6 Aluminum, 416 Stainless Steel, 17-4 Stainless Steel, and 4140 Alloy Steel.

In some embodiments of the cycloid drive, the outer-roller has a diameter of 3-12 mm, and in other embodiments the outer-roller has a diameter of 5-10 mm. In further embodiments, the outer-roller comprises an outer-roller pitch circle, wherein the outer-roller pitch circle has a diameter of 10 mm-150 mm, and in other embodiments the outer-roller pitch circle has a diameter of about 30 mm to about 120 mm.

In some embodiments of the cycloid drive, the set of mid-ring rollers comprises 6 rollers, and in another embodiment the set of mid-ring rollers comprises 8 rollers. In certain embodiments of the cycloid drive the mid-roller has a diameter of 5 mm to 20 mm, and in other embodiments the mid-roller has a diameter of about 10 mm to about 16 mm. In a further embodiment, the mid-roller comprises an mid-roller pitch circle, wherein the mid-roller pitch circle has a diameter of 10 mm-100 mm, and in a still further embodiment the mid-roller comprises an mid-roller pitch circle, wherein the mid-roller pitch circle has a diameter of about 30 mm to about 80 mm.

In a certain embodiment of the cycloid drive, the drive has a gear ratio of between 16:1 and 30:1, and in another embodiment the drive has a gear ratio of 24:1.

In another embodiment of the cycloid drive, the input-shaft has an input eccentricity of 0.5 to 3 mm, and in a further embodiment the input-shaft has an input eccentricity of about 1 mm to about 2 mm.

In some embodiments of the cycloid drive, the roller bearing has an outside diameter of between 20 mm-60 mm, and in another embodiment the roller bearing has an inside diameter of between 8 mm-40 mm.

In another embodiment a cycloid drive assembly with a through-bore tube is disclosed, wherein the cycloid drive assembly comprises: a roller bearing, wherein the roller bearing is eccentrically mounted to an input-shaft, and wherein the input-shaft is operatively coupled to receive torque from a motor, wherein the input-shaft in hollow and comprises an exterior surface, an interior surface, and a first diameter, wherein a through-bore tube of a second diameter is concentrically positioned within the hollow input-shaft such that the interior surface of the hollow input-shaft is adjacent to the external surface of the through-bore tube; a mid-ring, wherein the mid-ring comprises a set of mid-ring rollers, and is fixed to an stationary housing element; a pair of cycloid-discs, wherein each cycloid-disc comprises N external lobes, wherein each cycloid-disc is positioned onto the set of mid-ring rollers, and each cycloid-disc is out of phase by 180° relative to each other, and wherein each cycloid-disc comprises a wobble-motion produced by the roller bearing eccentrically mounted to the input-shaft; and an outer-roller-ring, wherein the outer-roller-ring comprises N+1 rollers, wherein the rollers are engaged by the N external lobes of each cycloid-disc, and the wobble-motion drives the outer-roller-ring with a reduced speed and an increased torque relative to the speed and torque received from the motor.

Disclosed herein, in a certain embodiment is an actuator, for the purpose of operatively connecting links in a kinematic serial chain, the actuator comprising: a housing, wherein the housing comprises: a stationary housing element, and an output housing element; a motor; an input encoder; an output encoder; and a cycloid drive assembly, wherein the cycloid drive assembly comprises: a hollow input-shaft; a through-bore tube of a first diameter wherein the through-bore tube is concentrically positioned within the hollow input-shaft and extends through the housing of the actuator forming a passthrough through the entire body of the actuator, wherein the through-bore tube receives a first element at a first joint in the kinematic serial chain, wherein the first element traverses the through-bore tube and operatively connects the first joint to a second joint in the kinematic serial chain, and wherein the input-shaft is operatively coupled to receive torque from a motor; a roller bearing, wherein the roller bearing is eccentrically mounted to the input-shaft; a mid-ring, wherein the mid-ring comprises a set of mid-ring rollers; a cycloid-disc, comprising N external lobes, wherein the cycloid-disc is positioned onto the set of mid-ring rollers; and an outer-roller-ring, wherein the outer-roller-ring comprises N+1 outer-rollers, and wherein the outer-roller-ring of the drive has a reduced speed and an increased torque relative to the hollow input-shaft. In a further embodiment, the actuator is a threadable cycloid actuator, comprising a cycloid drive as disclosed above.

These and other features and advantages will be apparent from a reading of the following detailed description and a review of the appended drawings. It is to be understood that the foregoing summary, the following detailed description and the appended drawings are explanatory only and are not restrictive of various aspects as represented in the clauses disclosed herein or as claimed.

### BRIEF DESCRIPTION OF THE DRAWINGS

The accompanying drawings, which are incorporated in and form a part of the specification, illustrate the embodiments of the invention and, together with the written description, serve to explain the principles, characteristics, and features of the invention.

In the drawings:

FIGS. 1-3 are, respectively, a first perspective view, a second perspective view, and a front profile view of a robot in accordance with at least some embodiments of the present technology with the robot being in a first state or pose.

FIGS. 4-7 are perspective views of a first arm, a second arm, a first leg, and a second leg, respectively, of the robot shown in FIG. 1.

FIGS. 8-11 are silhouette views of the first arm, the second arm, the first leg, and the second leg, respectively, of the robot shown in FIG. 1 illustrating corresponding arm and leg lengths.

FIGS. 12-15 are partially schematic diagrams showing kinematic chains corresponding, respectively, to the first arm, the second arm, the first leg, and the second leg of the robot shown in FIG. 1.

FIGS. 16-19 are partially transparent perspective views of the first arm, the second arm, the first leg, and the second leg, respectively, of the robot shown in FIG. 1 illustrating corresponding arm and leg actuators.

FIG. 20 is a side profile view of the first arm of the robot shown in FIG. 1 indicating isolated motion about an arm joint of the robot.

FIG. 21 is a front profile view of the first arm of the robot shown in FIG. 1 indicating isolated motion about an arm joint of the robot distal to the arm joint of FIG. 20 along the kinematic chain of FIG. 12.

FIG. 22 is a top plan view of the first arm of the robot shown in FIG. 1 indicating isolated motion about an arm joint of the robot distal to the arm joint of FIG. 21 along the kinematic chain of FIG. 12.

FIG. 23 is a side profile view of the first arm of the robot shown in FIG. 1 indicating isolated motion about an arm joint of the robot distal to the arm joint of FIG. 22 along the kinematic chain of FIG. 12.

FIGS. 24 and 25 are perspective views of a distal portion of the first arm of the robot shown in FIG. 1 indicating isolated motion about an arm joint of the robot distal to the arm joint of FIG. 23 along the kinematic chain of FIG. 12.

FIG. 26 is a side profile view of the first arm of the robot shown in FIG. 1 indicating isolated motion about an arm joint of the robot distal to the arm joint of FIGS. 24 and 25 along the kinematic chain of FIG. 12.

FIG. 27 is a top plan view of the first arm of the robot shown in FIG. 1 indicating isolated motion about an arm joint of the robot distal to the arm joint of FIG. 26 along the kinematic chain of FIG. 12.

FIG. 28 is a front profile view of the first leg of the robot shown in FIG. 1 indicating isolated motion about a leg joint of the robot along the kinematic chain of FIG. 14.

FIG. 29 is a top plan view of the first leg of the robot shown in FIG. 1 indicating isolated motion about a leg joint of the robot distal to the leg joint of FIG. 28 along the kinematic chain of FIG. 14.

FIG. 30 is a side profile view of the first leg of the robot shown in FIG. 1 indicating isolated motion about a leg joint of the robot distal to the leg joint of FIG. 29 along the kinematic chain of FIG. 14.

FIG. 31 is a side profile view of the first leg of the robot shown in FIG. 1 indicating isolated motion about two leg joints of the robot distal to the leg joint of FIG. 30 along the kinematic chain of FIG. 14.

FIGS. 32 and 33 are side profile views of the first leg of the robot shown in FIG. 1 indicating isolated motion about a leg joint of the robot distal to the leg joints of FIG. 31 along the kinematic chain of FIG. 14.

FIG. 34 is a block diagram illustrating an electrical and computer system of the robot shown in FIG. 1.

FIG. 35 is a block diagram illustrating a software architecture of the robot shown in FIG. 1.

FIG. 36 is a side cross-sectional view of a threadable cycloid actuator (along dashed line a-a′ of FIG. 39) for a robot joint in accordance with at least some embodiments of the present invention.

FIG. 37a is an exploded view of a key features of a cycloid drive assembly as comprised in the threadable cycloid actuator of FIG. 36.

FIG. 37b is an anterior view of an input-shaft comprising a concentrically positioned through-bore tube in accordance with at least some embodiments of the present invention.

FIGS. 38-39 are, respectively, a perspective view and an orthographic view, of a cycloid actuator oriented to display the anterior cycloid drive, in accordance with at least some embodiments of the present invention.

FIGS. 40 and 41 are, respectively, a first and second orthographic view of a cycloid disc in accordance with at least some embodiments of the present invention.

FIG. 42 is a side cross-sectional view of a first actuator operatively coupled to a second actuator via a first element in accordance with at least some embodiments of the present invention.

While implementation of the disclosed inventions are described herein by way of example, those skilled in the art will recognize that they are not limited to the embodiments or drawings described. It should be understood that the drawings and detailed description thereto are not intended to limit implementations to the particular form disclosed, but on the contrary, the intention is to cover all modifications, equivalents, and alternatives falling within the spirit and scope as defined by the appended clauses. It should also be understood that the term “about” when used in conjunction with a percentage or other numerical amount, means plus or minus 10% of that percentage or other numerical amount. For example, the term “about 80%” would encompass 80% plus or minus 8%. The headings used herein are not meant to be used to limit the scope of the description clauses or clauses.

### DETAILED DESCRIPTION

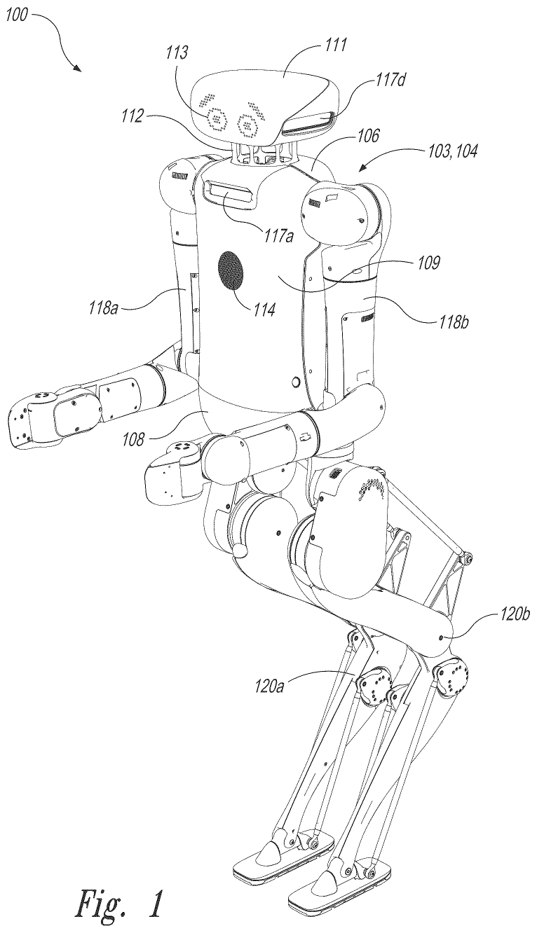

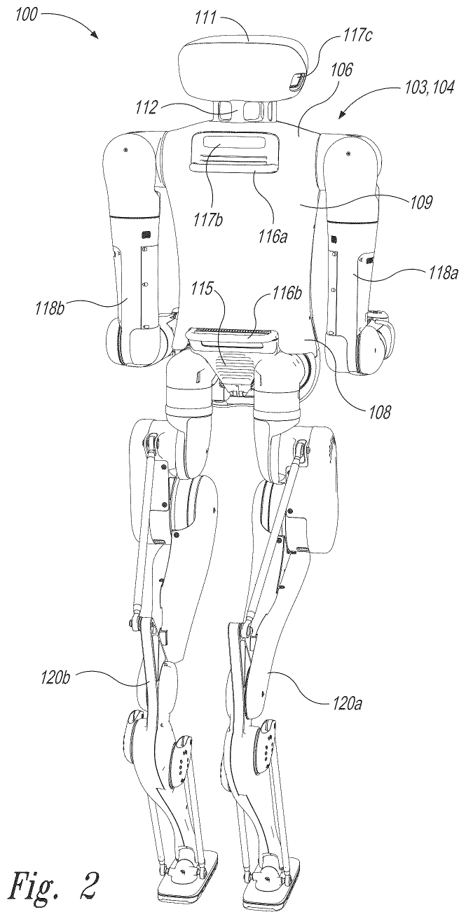

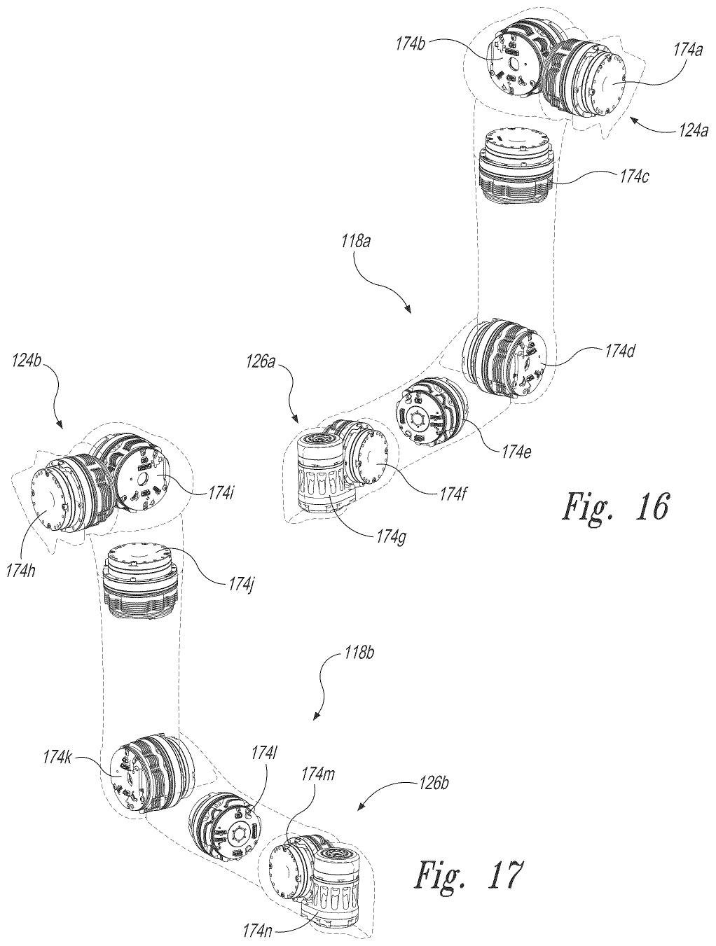

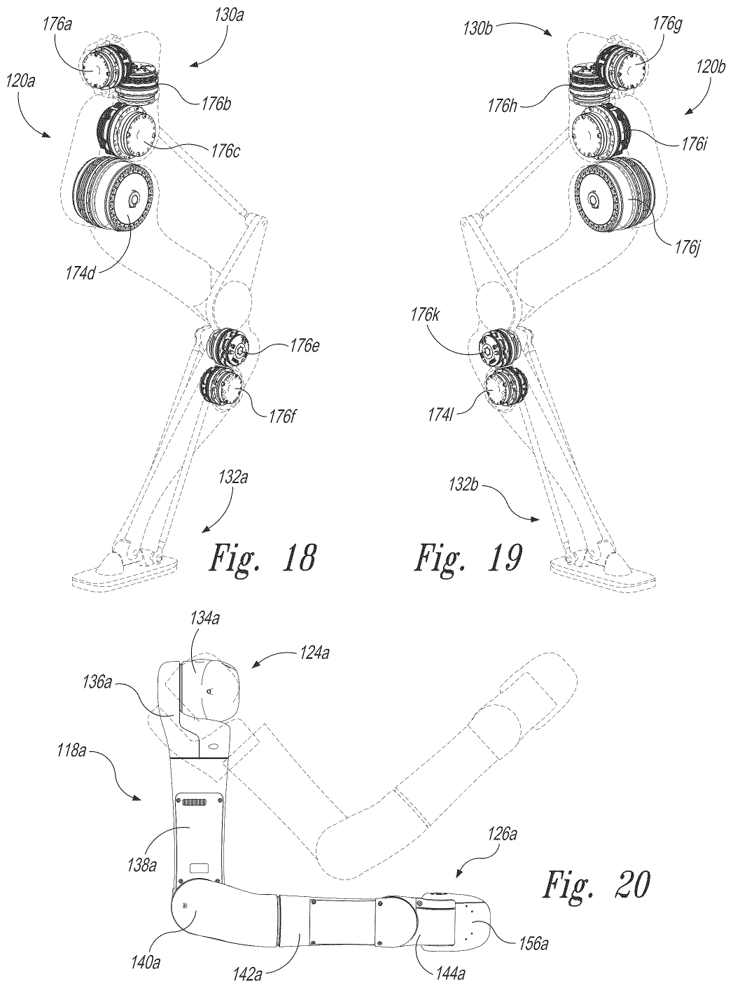

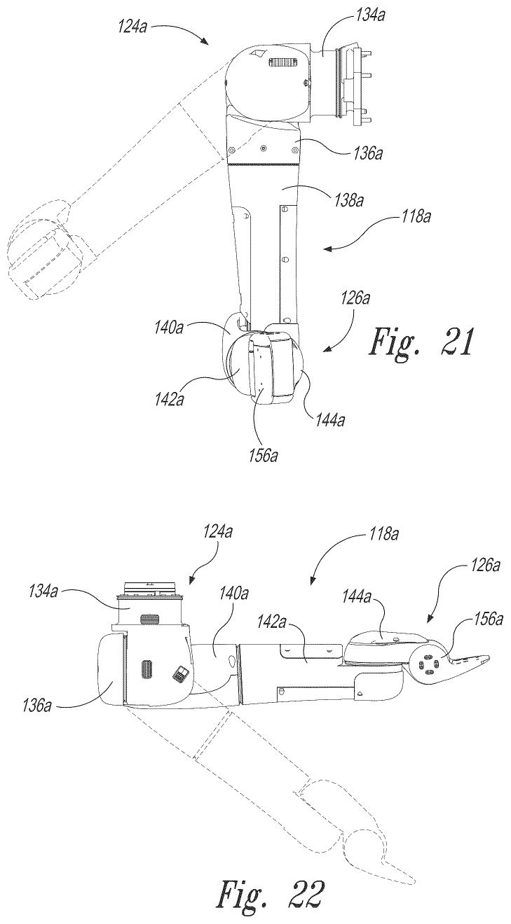

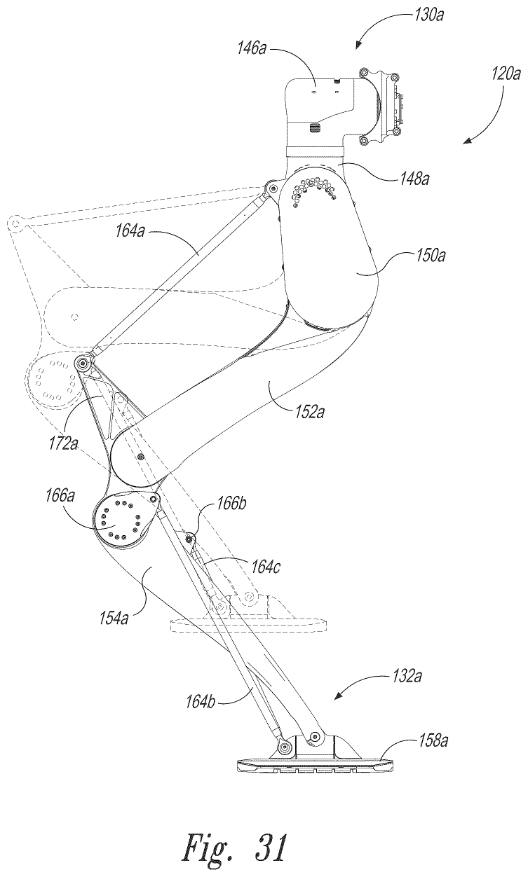

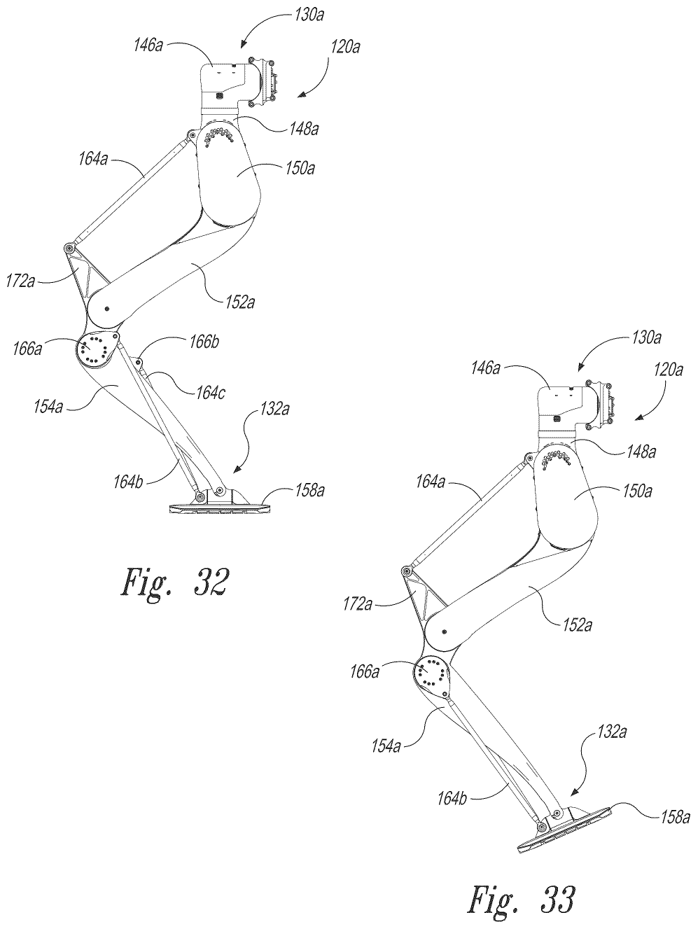

Disclosed herein are robots, and associated devices, systems, and methods. Features of robots, and associated devices, systems, and methods in accordance with various embodiments of the present invention are described below with reference to FIGS. 1-42.

Although devices, systems, and methods may be described herein primarily or entirely in the context of warehouse robots, other contexts are within the scope of the present invention. For example, suitable features of described devices, systems, and methods can be implemented in the context of robots that operate in non-warehouse environments, such as in the context of terrain-mapping robots, in the context of social robots, etc.

Furthermore, it should be understood, in general, that other devices, systems, and methods in addition to those disclosed herein are within the scope of the present invention. For example, devices, systems, and methods in accordance with embodiments of the present invention can have different and/or additional configurations, components, procedures, etc. than those disclosed herein. Moreover, devices, systems, and methods in accordance with embodiments of the present invention can be without one or more of the configurations, components, procedures, etc. disclosed herein without deviating from the present invention.

Thus, more particularly, the disclosed subject matter is directed to a threadable cycloid actuator, which comprises a cycloid drive with a through-bore. The cycloid drive is designed to be robust to high shock-loads and large torques and dimensioned in order to provide a means of passing or threading one or more of: wiring, cables, fluid lines, control lines, communication lines, and power lines through the actuator in order to provide connectivity and communication between kinematic links in a kinematic chain of a robot.

In a particularly desirable embodiment, a threadable cycloid actuator may be located in a knee joint of a bipedal robot leg, wherein a connective wire for example is passed through the knee joint actuator and connected to an actuator or a passive joint located at the next joint in the kinematic chain of the robot.

The knee joints of a robot carry the entire robot weight, and as the robot takes a step, the impact forces experienced by the robot foot on contact with the ground are transmitted along the length of the leg to the knee joint, wherein the forces are ultimately absorbed. Hence, the actuator located at the knee sees the highest torque and shock-load experienced by the robot.

The threadable cycloid actuator disclosed herein is designed in order to address the absorption of forces at the knee joint, and simultaneously provide a means of connecting the links in the robot kinematic chain such that they are internal to the robot architecture. Typically, wiring, cables, fluid lines, control lines, communication lines, and power lines used for connection, communication and function within such a kinematic chain have been located externally to the robot architecture, as it has not previously been possible to thread these elements through actuators located in the robot joints.

Such elements are therefore exposed and vulnerable to wear and impact, and thus may have a derogatory effect on the integrity and functional lifespan of useful working robots. A threadable cycloid actuator is thus beneficial for its ability to handle shock-load and high torque whilst additionally improving the overall efficiency of the robot, by providing an enclosed protective environment for wiring, which is less likely to be damaged, directly or indirectly by environmental hazards or wear. The utilization of a threadable cycloid actuator with a through-bore tube as disclosed herein results in a robot that has greater reliability, and requires less maintenance hours.

### The Robot

Disclosed herein, and illustrated in FIGS. 1 and 2 are different perspective views of a legged robot 100 in accordance with at least some embodiments of the present invention. FIG. 3 is a front profile view of the robot 100. As shown in FIGS. 1-3, the robot 100 can have a humanoid form. The robot 100 can include structures resembling human anatomy with respect to the features, positions, and/or other characteristics of such structures. In at least some cases, the robot 100 defines a midsagittal plane 102 about which the robot 100 is bilaterally symmetrical. In these and other cases, the robot 100 can be configured for bipedal locomotion similar to that of a human. Counterparts of the robot 100 can have other suitable forms and features. For example, a counterpart of the robot 100 can have a non-humanoid form, such as a canine form, an insectoid form, an arachnoid form, or a form with no animal analog. Furthermore a counterpart of the robot 100 can be asymmetrical or have symmetry other than bilateral. Still further, a counterpart of the robot 100 can be configured for non-bipedal locomotion. For example, a counterpart of the robot 100 can be configured for another type of legged locomotion (e.g quadrupedal locomotion, octo-pedal locomotion, etc.) and/or in some further embodiment wheeled locomotion, or continuous-track locomotion for example.

With reference again to FIGS. 1-3, the robot 100 can include a centrally disposed body 103 through which other structures of the robot 100 are interconnected. As all or a portion of the body 103, the robot 100 can include a torso 104 having a superior portion 106, an inferior portion 108, and an intermediate portion 109 there between. The robot 100 can define a transverse plane 110 from which the superior and inferior portions 106, 108 of the torso 104 are respectively superiorly and inferiorly spaced apart. The robot 100 can further include a head 111 superiorly spaced apart from the torso 104. The robot 100 can also include a neck 112 through which the head 111 is connected to the torso 104 via the superior portion 106 of the torso 104. The head 111 can have an anteriorly directed display 113 including light-emitting diodes selectively controllable to create a composite, pixelated image evocative of human facial expression. The robot 100 can further include an anteriorly directed audio transmissive window 114 at the intermediate portion 109 of the torso 104, a posteriorly directed exhaust vent 115 at the inferior portion 108 of the torso 104, and superior and inferior projections 116a, 116b extending, respectively, posteriorly from the superior portion 106 of the torso 104 and posteriorly from the inferior portion 108 of the torso 104. The robot 100 can still further include sensor arrays 117 (individually identified as sensor arrays 117a-117e) carried by the torso 104 and the head 111. The sensor arrays 117a, 117b can be at the superior portion 106 of the torso 104 and anteriorly and posteriorly directed, respectively. The sensor arrays 117c, 117d can be at opposite respective sides of the head 111 and can be directed in opposite respective lateral directions. The sensor array 117e can be at the inferior portion 108 of the torso 104 and directed anteriorly and inferiorly toward a ground level in front of the robot 100.

The robot 100 can further include articulated appendages carried by the torso 104. Among these articulated appendages, the robot 100 can include arms 118a, 118b and legs 120a, 120b. In at least some cases, the robot 100 is configured to manipulate objects via the arms 118a, 118b, such as bimanually. In these and other cases, the robot 100 can be configured to ambulate via the legs 120a, 120b, such as bipedally.

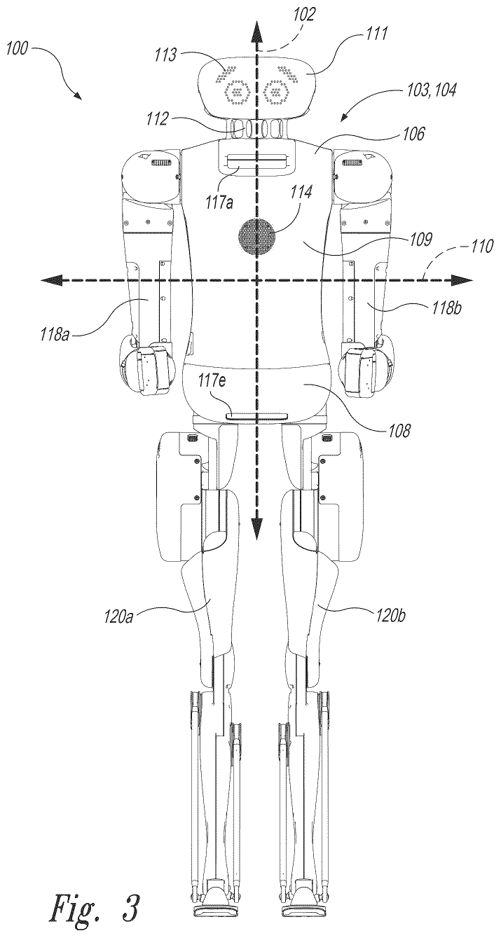

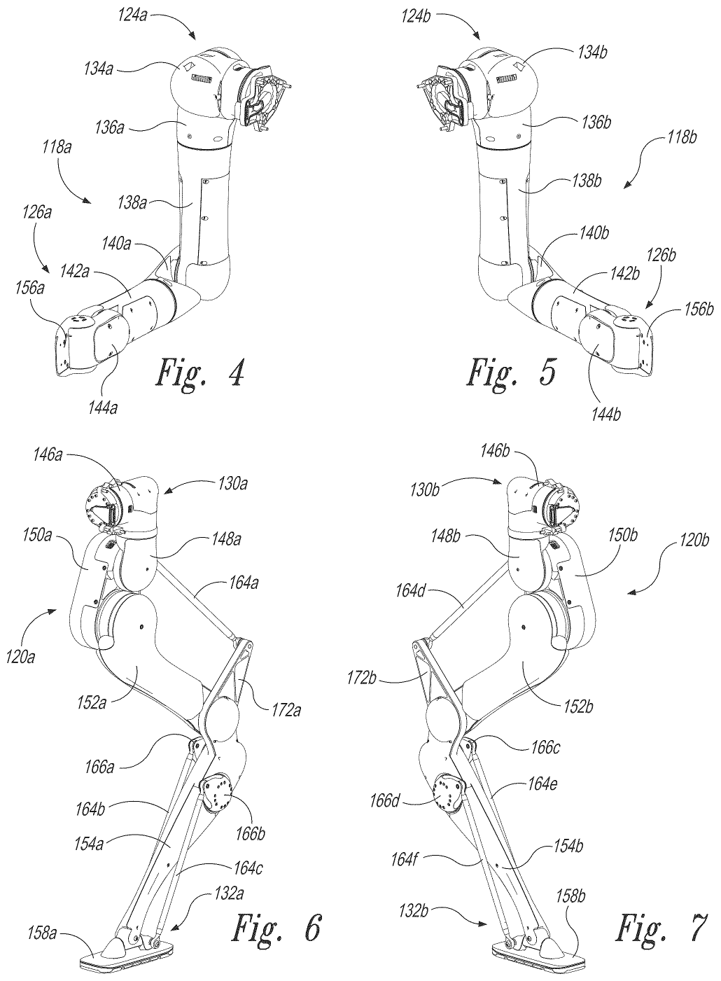

With reference to FIGS. 1-15 together (wherein FIGS. 12-15 are partially schematic diagrams showing kinematic chains corresponding to the arms 118a, 118b and legs 120a, 120b, respectively and in FIGS. 12-15, lines represent links, filled circles represent active joints, and open circles represent inactive joints) the arms 118a, 118b can define respective arm lengths 122a, 122b extending from the torso 104. For clarity of illustration, the arm lengths 122a, 122b are only indicated in FIGS. 8 and 9, respectively. The arms 118a, 118b can have respective proximal end portions 124a, 124b and respective distal end portions 126a, 126b at opposite ends of the respective arm lengths 122a, 122b. The arms 118a, 118b can be connected to the torso 104 via the respective proximal end portions 124a, 124b thereof and the superior portion 106 of the torso 104. Similar to the arms 118a, 118b, the legs 120a, 120b can define respective leg lengths 128a, 128b extending from the torso 104. For clarity of illustration, the leg lengths 128a, 128b are only indicated in FIGS. 10 and 11, respectively. The legs 120a, 120b can have respective proximal end portions 130a, 130b and respective distal end portions 132a, 132b at opposite ends of the respective leg lengths 128a, 128b. The legs 120a, 120b can be connected to the torso 104 via the respective proximal end portions 130a, 130b thereof and the inferior portion 108 of the torso 104.

The arms 118a, 118b and the legs 120a, 120b can define kinematic chains. In at least some cases, the kinematic chains corresponding to the arms 118a, 118b provide at least five degrees of freedom, such as exactly five or exactly six degrees of freedom. In these and other cases, the kinematic chains corresponding to the legs 120a, 120b can provide at least four degrees of freedom, such as exactly four, exactly five, or exactly six degrees of freedom. The robot 100 can include links at progressively more distal (i.e., lower) levels within the kinematic chains corresponding to the arms 118a, 118b and the legs 120a, 120b and at progressively more distal (i.e., farther) positions along the arm lengths 122a, 122b and the leg lengths 128a, 128b. As parts of the arms 118a, 118b, the robot 100 can include proximal shoulder links 134a, 134b, distal shoulder links 136a, 136b, upper arm links 138a, 138b, elbow links 140a, 140b, lower arm links 142a, 142b, and wrist links 144a, 144b. Similarly, as parts of the legs 120a, 120b, the robot 100 can include proximal hip links 146a, 146b, distal hip links 148a, 148b, proximal thigh links 150a, 150b, distal thigh links 152a, 152b, and calf links 154a, 154b.

As further parts of the arms 118a, 118b, the robot 100 can include end effectors 156a, 156b opposite to the proximal end portions 124a, 124b along the arm lengths 122a, 122b and distal to the wrist links 144a, 144b. As further parts of the legs 120a, 120b, the robot 100 can include feet 158a, 158b opposite to the proximal end portions 130a, 130b along the leg lengths 128a, 128b and distal to the calf links 154a, 154b. The end effectors 156a, 156b can be at distalmost positions along the arm lengths 122a, 122b. Similarly, the feet 158a, 158b can be at distalmost positions along the leg lengths 128a, 128b. In the illustrated embodiment, the end effectors 156a, 156b and the feet 158a, 158b are not articulated. In other embodiments, counterparts of some or all of the end effectors 156a, 156b and the feet 158a, 158b can be articulated, such as with one or more movable fingers or toes.

With reference again to FIGS. 1-15, the robot 100 can include arm joints 160 (individually identified as arm joints 160a-160n) as parts of the arms 118a, 118b. The arm joints 160a-160n can be disposed between neighboring links within the kinematic chains corresponding to the arms 118a, 118b and at opposite ends of these kinematic chains. For clarity of illustration, the arm joints 160 are only indicated in FIGS. 12 and 13. The robot 100 can further include leg joints 162 (individually identified as leg joints 162a-162l) as parts of the legs 120a, 120b. Similar to the arm joints 160a-160n, the leg joints 162a-162l can be disposed between neighboring links within the kinematic chains corresponding to the legs 120a, 120b and at opposite ends of these kinematic chains. For clarity of illustration, the leg joints 162 are only indicated in FIGS. 14 and 15. The arm joints 160a-160n and the leg joints 162a-162l may be referenced herein in connection with the distally neighboring link along the kinematic chain of the corresponding one of the arms 118a, 118b and the legs 120a, 120b. For example, the arm joints 160f, 160m may be referenced herein as the wrist joints 160f, 160m.

In FIGS. 1-3, the robot 100 is shown in a first state, which can correspond to a home pose, a neutral pose, etc. well-suited to an object-manipulation task. In the first state, the proximal shoulder links 134a, 134b can extend laterally from the torso 104. Also, in the first state, the distal shoulder links 136a, 136b and the upper arm links 138a, 138b can extend inferiorly from the proximal shoulder links 134a, 134b. Also, in the first state, the elbow links 140a, 140b, the lower arm links 142a, 142b, and the wrist links 144a, 144b can extend anteriorly from the upper arm links 138a, 138b. Also, in the first state, the proximal hip links 146a, 146b can extend posteriorly from the torso 104. Also, in the first state, the distal hip links 148a, 148b and the proximal thigh links 150a, 150b can extend inferiorly from the proximal hip links 146a, 146b. Also, in the first state, the distal thigh links 152a, 152b can extend inferiorly and posteriorly from the proximal thigh links 150a, 150b. Finally, in the first state, the calf links 154a, 154b can extend inferiorly and anteriorly from the distal thigh links 152a, 152b.

In at least some cases, the calf joints 162e, 162k and the foot joints 162f, 162l are passive. As additional parts of the legs 120a, 120b, the robot 100 can include connection shafts 164 (individually identified as connection shafts 164a-164f), cranks 166 (individually identified as cranks 166a-166d), ancillary active joints 168 (individually identified as ancillary active joints 168a-168d), and ancillary passive joints 170 (individually identified as ancillary passive joints 170a-170l). The connection shafts 164a, 164d can extend between the proximal thigh links 150a, 150b and the calf links 154a, 154b. When the robot 100 is in the first state, the connection shafts 164a, 164d can be posteriorly spaced apart from the distal thigh links 152a, 152b and within 10 degrees of parallel to (e.g., within 5 degrees of parallel to and/or substantially parallel to) corresponding portions of the leg lengths 128a, 128b. Moving the distal thigh joints 162d, 162j from their positions when the robot 100 is in the first state can cause the connection shafts 164a, 164d to move increasingly off parallel from the corresponding portions of the leg lengths 128a, 128b.

The calf links 154a, 154b can include projections 172a, 172b extending posteriorly and superiorly from the calf joints 162e, 162k. The ancillary passive joints 170a, 170b can be at opposite ends of the connection shaft 164a. Similarly, the ancillary passive joints 170g, 170h can be at opposite ends of the connection shaft 164d. Due to their kinematic arrangement, an actuated position of the distal thigh joint 162d can dictate positions of the calf joint 162e and of the ancillary passive joints 170a, 170b. Similarly, due to their kinematic arrangement, an actuated position of the distal thigh joint 162j can dictate positions of the calf joint 162k and of the ancillary passive joints 170g, 170h. The calf links 154a, 155b can carry the cranks 166a, 166c laterally. The calf links 154a, 155b can further carry the cranks 166b, 166d medially. The ancillary active joints 168a, 168b can be between the cranks 166a, 166b and the calf link 154a. Similarly, the ancillary active joints 168c, 168d can be between the cranks 166c, 166d and the calf link 154b.

The connection shafts 164b, 164c can extend between the cranks 166a, 166b and the foot 158a and can be spaced apart laterally and medially, respectively, from the calf link 154a. Similarly, the connection shafts 164e, 164f can extend between the cranks 166c, 166d and the foot 158b and can be spaced apart laterally and medially, respectively, from the calf link 154b. The ancillary passive joints 170c, 170e can be at opposite ends of the connection shaft 164b. The ancillary passive joints 170d, 170f can be at opposite ends of the connection shaft 164c. The ancillary passive joints 170i, 170k can be at opposite ends of the connection shaft 164e. Finally, the ancillary passive joints 170j, 170l can be at opposite ends of the connection shaft 164f. The ancillary active joints 168a, 168b can be configured to operate in concert to move the foot 158a relative to the calf link 154a. Due to their kinematic arrangement, actuated positions of the ancillary active joints 168a, 168b can dictate positions of the foot joint 162f and of the ancillary passive joints 170c-170f. Similarly, the ancillary active joints 168c, 168d can be configured to operate in concert to move the foot 158b relative to the calf link 154b. Due to their kinematic arrangement, actuated positions of the ancillary active joints 168c, 168d can dictate positions of the foot joint 162l and of the ancillary passive joints 170i-170l.

The relative orientations of the arm joints 160a-160l, the relative positions of the arm joints 160a-160l, the dimensions of the links within the kinematic chains corresponding to the arms 118a, 118b, the shapes of these links, and/or other features of the arms 118a, 118b can provide advantages over conventional alternatives. Examples of these advantages include enhanced maneuverability, enhanced range of motion, enhanced economy of motion, reduced occurrence of kinematic singularities during certain operations (e.g., object lifting, object carrying, etc.), closer emulation of human arm kinematics, and closer emulation of human arm conformation, among others. Furthermore, the relative orientations of the leg joints 162a-162l, the relative positions of the leg joints 162a-162l, the dimensions of the links within the kinematic chains corresponding to the legs 120a, 120b, the shapes of these links, and/or other features of the legs 120a, 120b can provide advantages over conventional alternatives. Examples of these advantages include enhanced maneuverability, enhanced range of motion, enhanced economy of motion, reduced occurrence of kinematic singularities during certain operations (e.g., walking, running, etc.), closer emulation of human leg kinematics, and closer emulation of human leg conformation, among others.

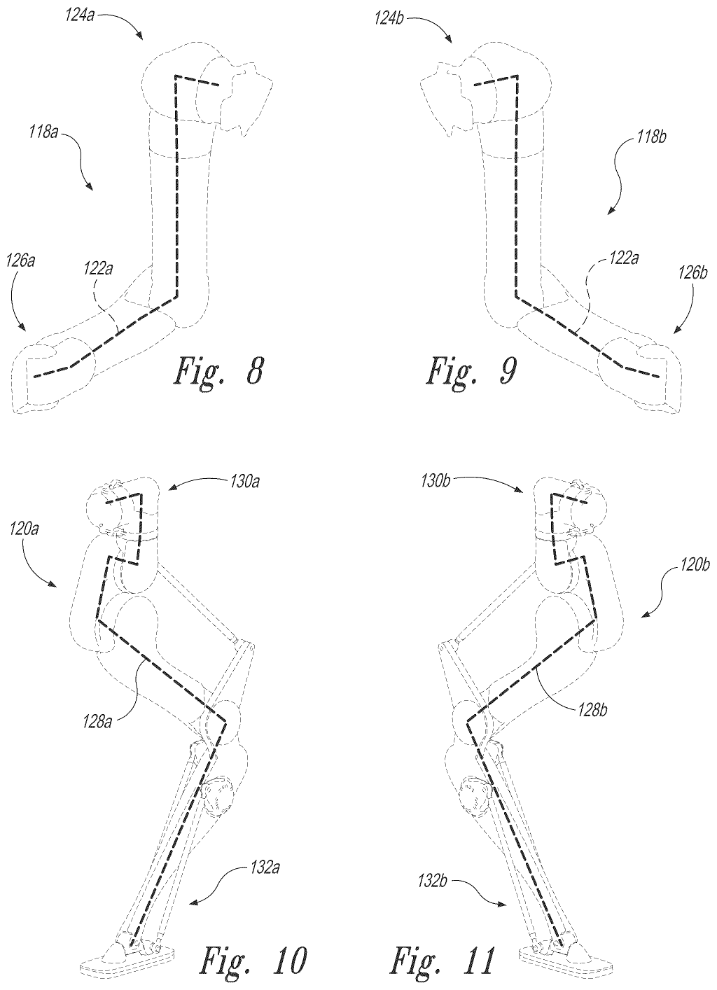

FIGS. 16 and 17 are partially transparent perspective views of the arms 118a, 118b, respectively. As shown in FIGS. 16 and 17, the robot 100 can include arm actuators 174 (individually identified as arm actuators 174a-174n) as parts of the arms 118a, 118b. The arm actuators 174a-174n can be embedded within, mounted to, or otherwise carried by the links within the kinematic chains corresponding to the arms 118a, 118b. In the illustrated embodiment, the arm actuators 174a-174n are incorporated into the arms 118a, 118b in the following manner. The arm actuators 174a, 174h are embedded within portions of the proximal shoulder links 134a, 134b at the proximal shoulder joints 160a, 160h. The arm actuators 174b, 174i are embedded within portions of the proximal shoulder links 134a, 134b at the distal shoulder joints 160b, 160i. The arm actuators 174c, 174j are embedded within portions of the upper arm links 138a, 138b at the upper arm joints 160c, 160j. The arm actuators 174d, 174k are embedded within portions of the upper arm links 138a, 138b at the elbow joints 160d, 160k. The arm actuators 174e, 174l are embedded within portions of the lower arm links 142a, 142b at the lower arm joints 160e, 160l. The arm actuators 174f, 174m are embedded within portions of the lower arm links 142a, 142b at the wrist joints 160f, 160m. Finally, the arm actuators 174g, 174n are embedded within portions of the wrist links 144a, 144b at the end effector joints 160g, 160n.

FIGS. 18 and 19 are partially transparent perspective views of the legs 120a, 120b, respectively. As shown in FIGS. 18 and 19, the robot 100 can include leg actuators 176 (individually identified as leg actuators 176a-176l) as parts of the legs 120a, 120b. The leg actuators 176a-176l can be embedded within, mounted to, or otherwise carried by the links within the kinematic chains corresponding to the legs 120a, 120b. In the illustrated embodiment, the leg actuators 176a-176l are incorporated into the legs 120a, 120b in the following manner. The leg actuators 176a, 176g are embedded within portions of the proximal hip links 146a, 146b at the proximal hip joints 162a, 162g. The leg actuators 176b, 176h are embedded within portions of the proximal hip links 146a, 146b at the distal hip joints 162b, 162h. The leg actuators 176c, 176i are embedded within portions of the proximal thigh links 150a, 150b at the proximal thigh joints 162c, 162i. The leg actuators 176d, 176j are embedded within portions of the proximal thigh links 150a, 150b at the distal thigh joints 162d, 162j. The leg actuators 176e, 176k are embedded within portions of the calf links 154a, 154b spaced apart from the foot joints 162f, 162l along the corresponding leg lengths 128a, 128b and are operably connected to the foot joints 162f, 162l via the cranks 166a, 166c and the connection shafts 164a, 164c. Finally, the leg actuators 176f, 176l are embedded within portions of the calf links 154a, 154b spaced apart from the foot joints 162f, 162l and distal to the leg actuators 176e, 176k along the corresponding leg lengths 128a, 128b and are operably connected to the foot joints 162f, 162l via the cranks 166b, 166d and the connection shafts 164b, 164d.

In at least some cases, the arm actuators 174a-174n and the leg actuators 176a-176l are rotary actuators including electric servo motors and corresponding strain wave gear units. This combination can be characterized by relatively high torque density, compact size, high efficiency, and low backlash, among other potentially advantageous features. In other cases, counterparts of some or all of the arm actuators 174 and the leg actuators 176 can be pneumatic or hydraulic rather than electric, be linear rather than rotary, be stepper-type rather than servo-type, be direct drive rather than geared, and/or have gearing other than strain wave (e.g., cycloid, spur, helical, miter, worm, rack, bevel, screw, etc.).

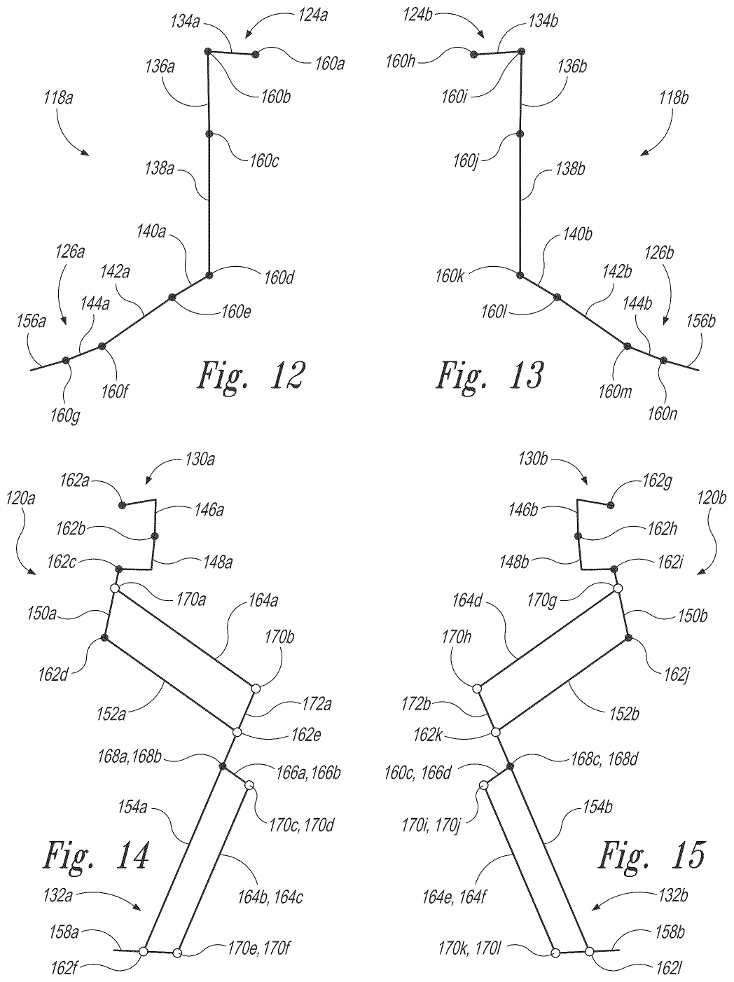

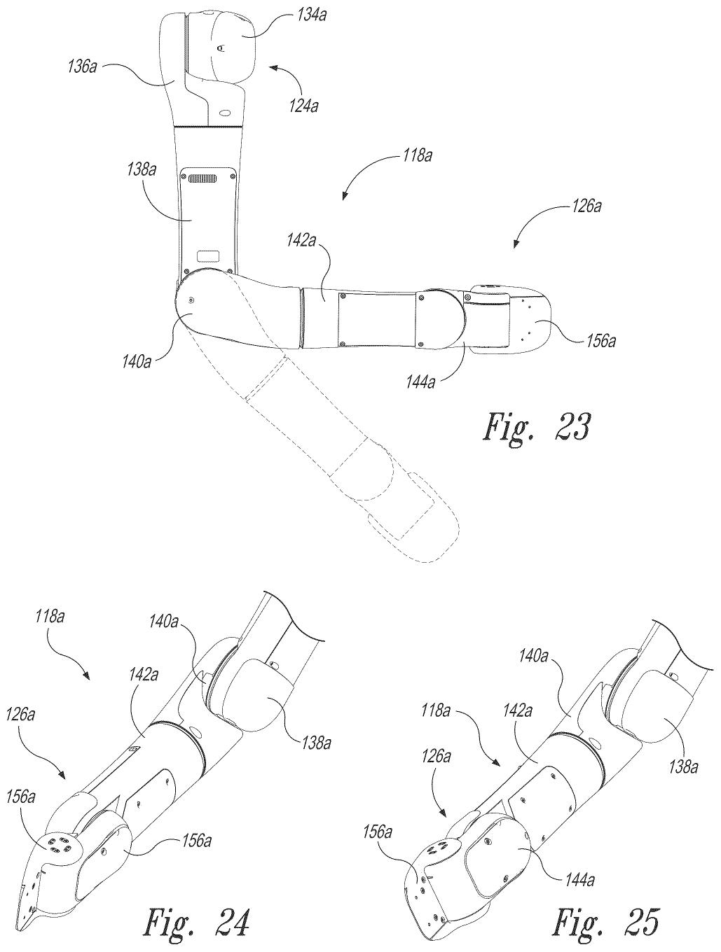

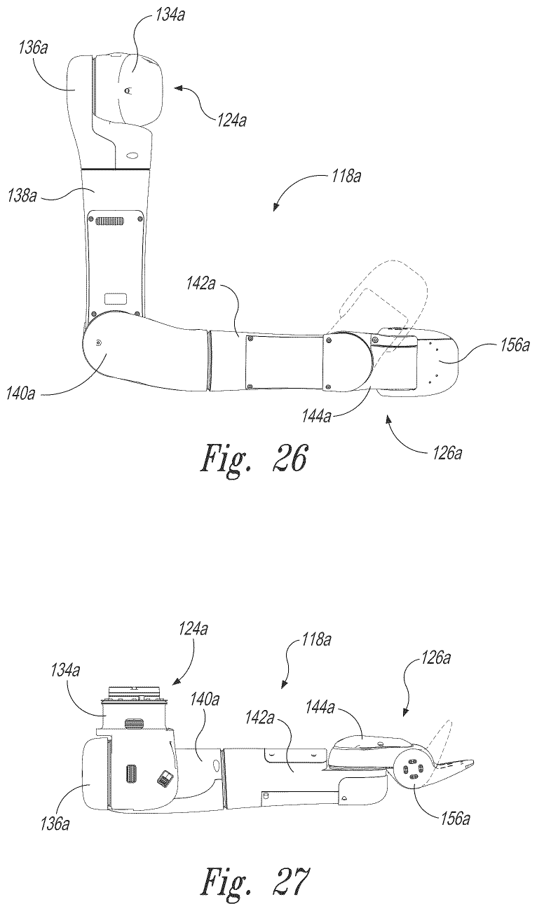

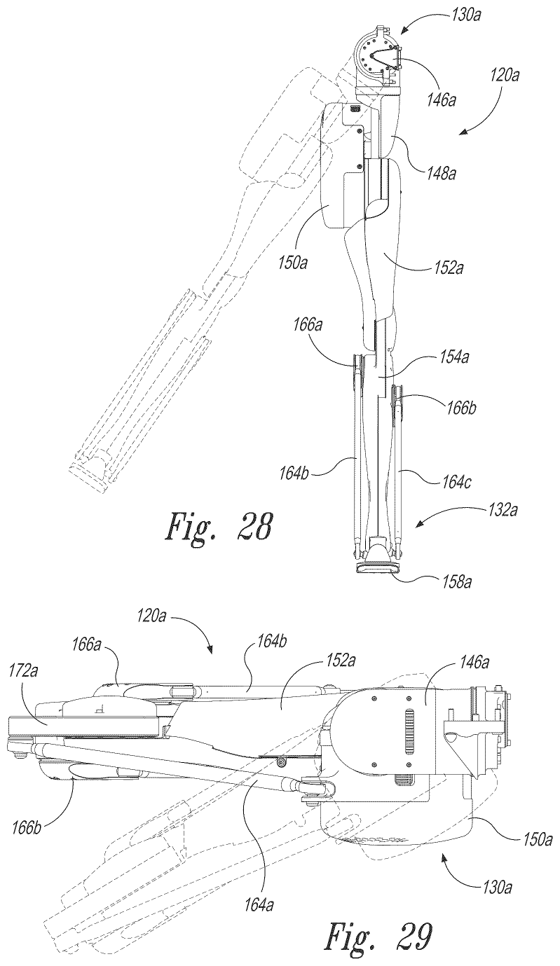

FIGS. 20-23 are various views of the arm 118a indicating isolated motion about the proximal shoulder joint 160a, the distal shoulder joint 160b, the upper arm joint 160c, and the elbow joint 160d, respectively. FIGS. 24 and 25 are perspective views of a distal portion of the arm 118a indicating isolated motion about the lower arm joint 160e. FIGS. 26 and 27 are a side profile view and a top plan view, respectively, of the arm 118a indicating isolated motion about the wrist joint 160f and the end effector joint 160g, respectively. Motion about the arm joints 160h-160n of the arm 118b can correspond symmetrically about the midsagittal plane 102 (FIG. 3) to the motion about the arm joints 160a-160g of the arm 118a shown in FIGS. 20-27. In at least some cases, the proximal shoulder joints 160a, 160h, the upper arm joints 160c, 160j, and the lower arm joints 160e, 160l are configured to rotate about respective axes parallel to the corresponding arm lengths 122a, 122b. In these and other cases, the distal shoulder joints 160b, 160i, the elbow joints 160d, 160k, the wrist joints 160f, 160m, and the end effector joints 160g, 160n can be configured to rotate about respective axes off-parallel to (e.g., within 10 degrees of perpendicular to, within 5 degrees of perpendicular to and/or substantially perpendicular to) the corresponding arm lengths 122a, 122b.

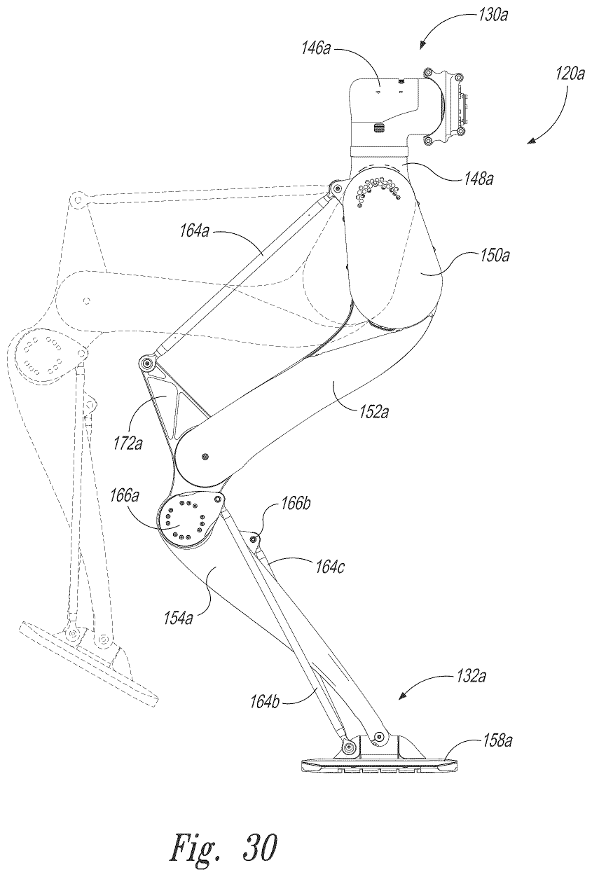

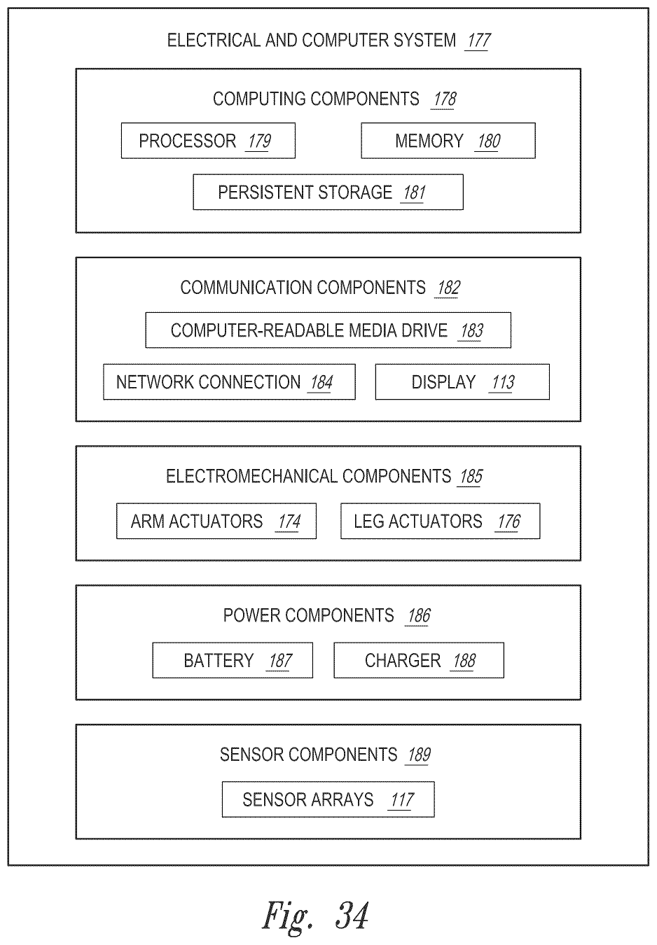

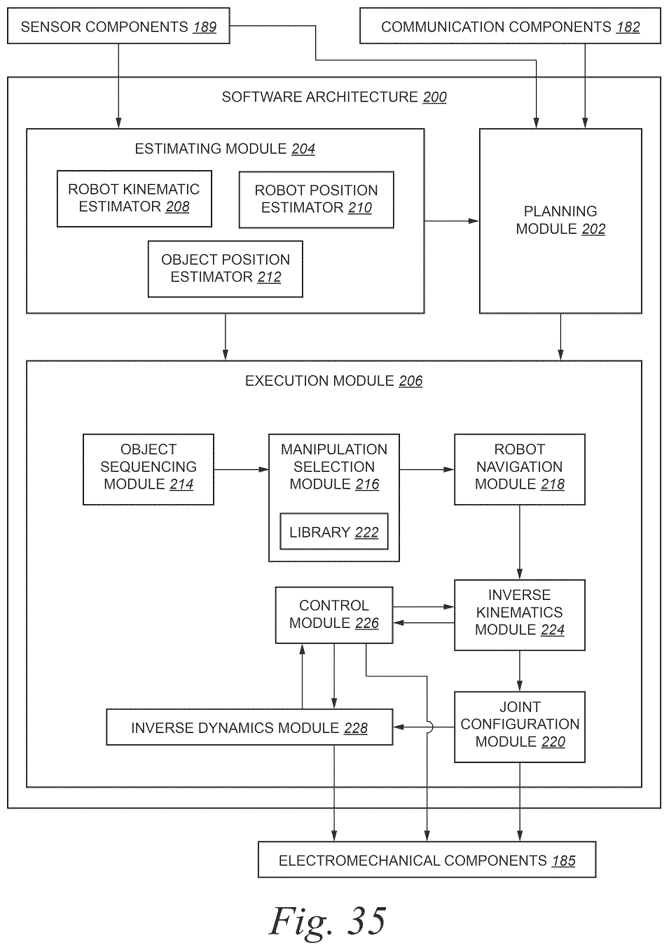

FIGS. 28-30 are various views of the leg 120a indicating isolated motion about the proximal hip joint 162a, the distal hip joint 162b, and the proximal thigh joint 162c, respectively. FIG. 31 is a side profile view of the leg 120a indicating isolated motion about both the distal thigh joint 162d and the calf joint 162e. FIGS. 32 and 33 are side profile views of the leg 120a indicating isolated motion about the foot joint 162f. Motion about the leg joints 162g-162l of the leg 120b can correspond symmetrically about the midsagittal plane 102 (FIG. 3) to the motion about the leg joints 162a-160f of the leg 120a shown in FIGS. 28-33. In at least some cases, the proximal hip joints 162a, 162g and the distal hip joints 162b, 162h are configured to rotate about respective axes parallel to the corresponding leg lengths 128a, 128b. In these and other cases, proximal thigh joints 162c, 162i, the distal thigh joints 162d, 162j, the calf joints 162e, 162k, and the foot joints 162f, 162l can be configured to rotate about respective axes off-parallel to (e.g., within 10 degrees of perpendicular to, within 5 degrees of perpendicular to and/or substantially perpendicular to) the corresponding leg lengths 128a, 128b. Further embodiments of robot 100, are disclosed in U.S. non-provisional patent application Ser. No. 18/061,868, which is incorporated herein in its entirety by reference.

### Examples of Electrical and Computer Systems

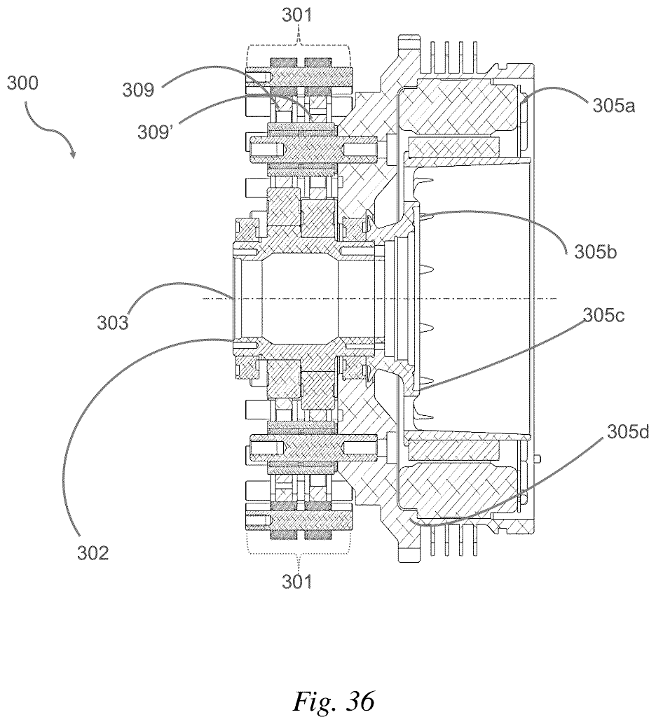

FIG. 34 is a block diagram illustrating an electrical and computer system 177 of the robot 100. When suitable, operations described elsewhere in this disclosure (e.g., movements of the robot 100) can be implemented via this electrical and computer system 177 autonomously and/or in response to instructions from a user. As shown in FIG. 34, the electrical and computer system 177 can include computing components 178. The computing components 178 can include a processor 179, such as one or more general-purpose and/or special-purpose integrated circuits including digital logic gates for executing programs and/or for otherwise processing data. The computing components 178 can further include memory 180, such as one or more integrated circuits for storing data in use. The memory 180 can include a multithreaded program, an operating system including a kernel, device drivers, etc. The computing components 178 can further include persistent storage 181, such as a hard drive for persistently storing data. Examples of data that can be stored by the persistent storage 181 include diagnostic data, sensor data, configuration data, environmental data, and current-state data. The computing components 178 can collectively define a computer configured to manage, control, receive information from, deliver information to, and/or otherwise usefully interact with other components of the electrical and computer system 177.

The electrical and computer system 177 can further include communication components 182. The communication components 182 can include a computer-readable media drive 183 for reading computer programs and/or other data stored on computer-readable media. As one example, the computer-readable media drive 183 can be a flash-memory drive. The communication components 182 can further include a network connection 184 for connecting the robot 100 to other devices and systems, such as other robots and/or other computer systems. The network connection 184 can be wired and/or wireless and can be via the Internet, a Local Area Network (LAN), a Wide Area Network (WAN), BLUETOOTH, WiFi, a cell phone network, etc. The network connection 184 can include networking hardware, such as routers, switches, transmitters, receivers, computer-readable transmission media, etc. The communication components 182 can further include the display 113 discussed above and/or other suitable components for communicating with a user. The robot 100 can use the communication components 182 for internal operations and/or to interact with devices and/or systems external to the robot 100, such as systems for providing contextual information about the environment in which the robot 100 operates and/or systems for changing operating conditions of the robot 100.

The electrical and computer system 177 can further include electromechanical components 185. The electromechanical components 185 can include the arm actuators 174 and the leg actuators 176 discussed above and/or other suitable components for implementing mechanical action within the robot 100. The electrical and computer system 177 can further include power components 186. The power components 186 can include a battery 187 and a charger 188. The battery 187 can be a lithium-ion battery, a lead-acid battery, or another suitable type. The charger 188 can include a connector (not shown) compatible with a power source (e.g., a wall outlet) and leads (also not shown) extending between the connector and the battery 187. In at least some cases, the robot 100 is configured to operate wirelessly via the battery 187 and to recharge occasionally via the charger 188.

Finally, the electrical and computer system 177 can include sensor components 189 for capturing, providing, and/or analyzing information about the robot 100 itself and/or the environment in which the robot 100 is operating. The sensor components 189 can include the sensor arrays 117 discussed above. At the sensor arrays 117 and/or at one or more other suitable locations, the robot 100 can include among the sensor components 189 a light sensor (e.g., a photoresistor), a sound sensor (e.g., a microphone), a location sensor (e.g., using the Global Positioning System), a distance sensor, and/or a proximity sensor, among other examples. Within the body 103 and/or at one or more other suitable locations, the robot 100 can include among the sensor components 189 an accelerometer, a gyroscope, a magnetometer, and/or a tilt sensor, among other examples. At the end effectors 156a, 156b and/or at one or more other suitable locations, the robot 100 can include among the sensor components 189 a contact sensor and/or a force sensor, among other examples. In at least some cases, two or more different types of sensors are incorporated into a sensor assembly. For example, an accelerometer, a gyroscope, and a magnetometer can be incorporated into an inertial measurement unit through which the robot 100 can determine acceleration, angular velocity, and orientation.

At one, some, or all of the arm and leg actuators 174, 176 and/or at one or more other suitable locations, the robot 100 can include among the sensor components 189 sensors that measure properties of the corresponding arm and leg joints 160, 162. Such properties can include position, orientation (e.g., yaw, pitch, and roll), applied force (e.g., torque), elevation, mass, velocity, and acceleration, among other examples. The measurements of these properties can be direct or indirect. As an example, of direct sensing, the robot 100 may sense a torque acting on a given one of the arm joints 160 via a torque sensor of one of the arm actuators 174 operably associated with the arm joints 160. As an example of indirect sensing, the robot 100 may sense a position of a given one of the end effectors 156a, 156b based on perception data corresponding to the given one of the end effectors 156a, 156b and other perception data corresponding to a reference. The robot 100 can include one or more sensors in a sensor system, such as a vision system, a light detection and ranging (LIDAR) system, a sound navigation and ranging (SONAR) system, etc. In at least some cases, the robot 100 monitors itself and/or its environment in real-time or in near real-time. Moreover, the robot 100 may use acquired sensor data as a basis for decision-making via the computing components 178.

Components of the electrical and computer system 177 can be connected to one another and/or to other components of the robot 100 via suitable conductors, transmitters, receivers, circuitry, etc. While the electrical and computer system 177 configured as described above may be used to support operation of the robot 100, it should be appreciated that the robot 100 may be operated using devices of various types and configurations and that such devices may have various components and levels of responsibility. For example, the robot 100 may employ individual computer systems or controllers to manage discrete aspects of its operations, such as an individual computer system or controller to perform computer vision operations, a separate computer system or controller to perform power management, etc. In some cases, the robot 100 employs the electrical and computer system 177 to control physical aspects of the robot 100 according to one or more designated rules encoded in software. For example, these rules can include minimums and/or maximums, such as a maximum degree of rotation for a joint, a maximum speed at which a component is allowed to move, a maximum acceleration rate for one or more components, etc. The robot 100 may include any number of mechanical aspects and associated rules, which may be based on or otherwise configured in accordance with the purpose of and/or functions performed by the robot 100.

Software features of the robot 100 may take the form of computer-executable instructions, such as program modules executable by the computing components 178. Generally, program modules include routines, programs, objects, components, data structures, and/or the like configured to perform particular tasks or to implement particular abstract data types and may be encrypted. Furthermore, the functionality of the program modules may be combined or distributed as desired in various examples. Moreover, control scripts may be implemented in any suitable manner, such as in C/C++ or Python. The functionality of the program modules may be combined or distributed in various embodiments, including cloud-based implementations, web applications, mobile applications for mobile devices, etc. Furthermore, certain aspects of the present technology can be embodied in a special purpose computer or data processor, such as application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a Local Area Network (LAN), Wide Area Network (WAN), or the Internet. In a distributed computing environment, program modules and other components may be located in both local and remote memory storage and other devices, which may be in communication via one or more wired and/or wireless communication channels.

Aspects of the present technology may be stored or distributed on tangible computer-readable media, which can include volatile and/or non-volatile storage components, such as magnetically or optically readable computer media, hard-wired or pre-programmed chips (e.g., EEPROM semiconductor chips), nanotechnology memory, biological memory, or other computer-readable storage media. Alternatively, computer-implemented instructions, data structures, screen displays, and other data under aspects of the present technology may be distributed (encrypted or otherwise) over the Internet or over other networks (including wireless networks), on a propagated signal on a propagation medium (e.g., electromagnetic wave(s), sound wave(s), etc.) over a period of time, or they may be provided on any analog or digital network (packet switched, circuit switched, or other scheme). Furthermore, the term computer-readable storage medium does not encompass signals (e.g., propagating signals) or transitory media. One of ordinary skill in the art will recognize that various components of the robot 100 may communicate via any number of wired and/or wireless communication techniques and that elements of the robot 100 may be distributed rather than located in a single monolithic entity. Finally, electrical and computing aspects of robots in accordance with various embodiments of the present technology may operate in environments and/or according to processes other than the environments and processes described above.

### Examples of Software Architecture Related to Object Manipulation

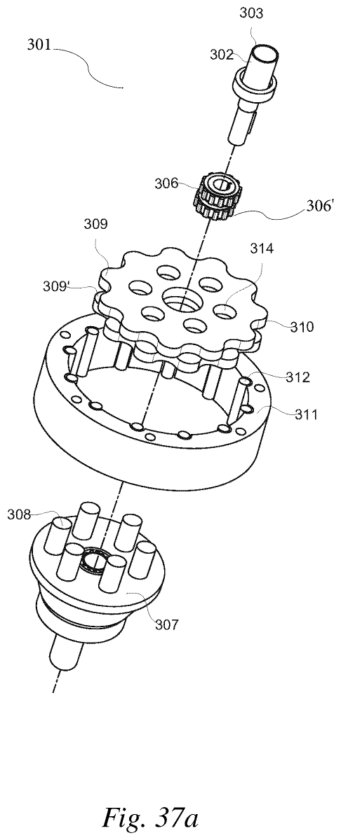

FIG. 35 is a block diagram illustrating selected portions of a software architecture 200 of the robot 100. The software architecture 200 can be within the software features of the electrical and computer system 177 described above in connection with FIG. 34. With reference to FIGS. 34 and 35 together, the software architecture 200 can include a planning module 202, an estimating module 204, and an execution module 206 operably associated with one other. The planning module 202 can be configured to relay or to generate a plan corresponding to an objective for the robot 100 (e.g., unload all objects on a shelf, retrieve an object from a first location and move the object to a second location, etc.). In at least some cases, the planning module 202 receives information from the communication components 182 and relays or generates a plan based at least partially on the received information. For example, the planning module 202 can receive a command from a user via the communication components 182 and relay the command as a plan. As another example, the planning module 202 can receive a command from a user via the communication components 182 and generate a plan related to the command. As yet another example, the planning module 202 can generate a plan without receiving a command from a user, such as at a predetermined time or in response to information about a current state of the robot 100 or the environment from the sensor components 189.

The estimating module 204 can receive information from the sensor components 189 and can generate estimates in real time or in near real time to inform generating and/or executing a plan. The estimating module 204 can include a robot kinematic estimator 208, a robot position estimator 210, and an object position estimator 212. The robot kinematic estimator 208 can generate an estimate of a current kinematic state of the robot 100 (e.g., balanced, off-balance, walking, standing, etc.) and estimates of positions of individual joints of the robot 100. The robot position estimator 210 can generate a current estimate of a position of the robot 100 within an environment. The robot position can be a set of coordinates and can be based on, for example, perception information and/or GPS information. Perception information relevant to the robot position includes, among other examples, information corresponding to distances between the robot 100 and landmarks in an environment as detected, for example, via a LIDAR system of the robot 100. The object position estimator 212 can generate estimates of the positions of relevant objects (e.g., totes to be manipulated) in an environment. As with the robot position, the object positions can be sets of coordinates and can be based on perception information. Perception information relevant to the object positions include, among other examples, information corresponding to fiducial markings carried by or otherwise associated with the objects as detected, for example, via an optical sensor of the robot 100.

The execution module 206 can be configured to receive a plan from the planning module 202 and estimates from the estimating module 204. The execution module 206 can include an object sequencing module 214, a manipulation selection module 216, a robot navigation module 218, and a joint configuration module 220. The planning module 202 can be configured to send a plan to the object sequencing module 214, to the manipulation selection module 216, to the robot navigation module 218, or to the joint configuration module 220 based on attributes of the plan. For example, when a plan includes explicit instructions for positions of the electromechanical components 185, the planning module 202 can send the plan to the execution module 206 via the joint configuration module 220. As another example, when a plan does not involve manipulating an object, the planning module 202 can send the plan to the execution module 206 via the robot navigation module 218. As yet another example, when a plan concerns only one object and the object is remote to the robot 100, the planning module 202 can send the plan to the execution module 206 via the manipulation selection module 216. As a final example, when a plan concerns multiple objects remote to the robot 100, the planning module 202 can send the plan to the execution module 206 via the object sequencing module 214.

The object sequencing module 214 can receive one or more estimates from the estimating module 204 and can generate a sequence in which multiple objects are to be manipulated. For example, when the object sequencing module 214 receives a plan to unload a shelf, the object sequencing module 214 can query the estimating module 204 for current locations of objects on the shelf. The object sequencing module 214 can then assign the objects an order, convert the order into a queue, and pass the queue to the manipulation selection module 216. The manipulation selection module 216 can include a library 222 including two or more different motion sequences that can be used to manipulate an object. Selected examples of these motion sequences are described below with reference to FIGS. 46-70. The manipulation selection module 216 can select a motion sequence for a given object based on the position of the object. For example, if the position of an object is such that locations on the object well suited for establishing a stable bimanual grasp of the object are kinematically accessible to the robot 100 (e.g., because the object is at or near the level of the torso 104 of the robot 100), the manipulation selection module 216 can select a motion sequence that includes lifting the object without first repositioning the object. In contrast, if an object is more difficult for the robot 100 to reach, the manipulation selection module 216 can select a motion sequence that includes repositioning the object to a more accessible position before lifting the object.

The robot navigation module 218 can generate targets for different parts of the robot 100 further to a plan or to a portion of a plan being executed. Examples of targets include positions of the feet 158a, 158b in the environment, positions of the end effectors 156a, 156b in the environment, etc. The robot navigation module 218 can update these targets continuously or near continuously based on information from the estimating module 204. The execution module 206 can further include an inverse kinematics module 224 that translates the targets from the robot navigation module 218 into joint configurations throughout the robot 100. The execution module 206 can also include a control module 226 that receives joint configurations from the inverse kinematics module 224 and generates joint parameters (e.g., positions, velocities, accelerations, etc.) to be executed by the robot 100 to achieve these joint configurations. Through continuous or near-continuous communication with the inverse kinematics module 224, the control module 226 can modify the joint parameters to at least partially compensate for deviations as the robot 100 executes the joint configurations. The inverse kinematics module 224 can send other joint configurations not subject to active control to the joint configuration module 220. Similar to the control module 226, the joint configuration module 220 can generate joint parameters (e.g., positions, velocities, accelerations, etc.) to be executed by the robot 100 to achieve joint configurations received from the inverse kinematics module 224 or from the planning module 202. The execution module 206 can include an inverse dynamics module 228 that receives joint parameters from the control module 226 and from the joint configuration module 220. The inverse dynamics module 228 can track a desired wrench of the robot 100 and its relationship with objects in the environment. In at least some cases, the inverse dynamics module 228 references a map of robot positions and wrenches to joint torques. Based at least partially on the tracking, the inverse dynamics module 228 can modify the joint parameters to achieve a desired result. For example, the inverse dynamics module 228 can modify the joint parameters to maintain contact between a tote and a support as the robot 100 drags the tote toward the body 103. The inverse dynamics module 228 can then send modified joint parameters to the electromechanical components 185 for execution. For configurations that do not involve a dynamic interaction with the environment, the control module 226 and the joint configuration module 220 can send joint parameters directly to the electromechanical components 185 for execution. One of ordinary skill in the art will recognize that various components of the robot 100 may communicate via any number of wired and/or wireless communication techniques and that elements of the robot 100 may be distributed rather than located in a single monolithic entity. Finally, electrical and computing aspects of robots in accordance with various embodiments of the present invention may operate in environments and/or according to processes other than the environments and processes described above.

### Examples of Actuators and Gear Sets for Joints in Kinematic Chains

As disclosed herein, the kinematic links of a robot comprise both robot arms and legs as illustrated in FIGS. 12-15. Arm actuators 174a-174n (FIGS. 16-17) and the leg actuators 176a-176l (FIGS. 18-19) may comprise rotary actuators including electric servo motors and corresponding strain wave gear units, and in other cases, counterparts of some or all of the arm actuators 174 and the leg actuators 176 can be pneumatic or hydraulic rather than electric. However, when considering development of actuators, particularly for the robot joints of the kinematic chains disclosed herein, many parameters are weighed. The complexity, weight and efficiency of the actuator, along with its ability to handle backdriving torque, reflected inertia, shock-load capability, peak output torque, etc. are considered. While in some embodiments strain wave actuators may be utilized, which are simplistic in design and light, in other embodiments it may be more desirable to use cycloid actuators. Cycloid actuators however, are more complex, require more parts, and are thus heavier than strain wave actuators, but benefits include being more backdrivable, and more capable of handling shock-load.

Cycloid actuators are more efficient than strain wave actuators. For example, in a strain wave actuator, sensors are often required to measure the actual output torque because the gear set is only about 75% efficient, but this efficiency can vary over time. Because of this, the commanded output torque differs from the actual output torque by an unknown amount. The output torque therefore cannot be reliably predicted. Actuators outfitted with cycloid drives however, are particularly good at transmitting commanded torque and handling shock-load, in part because the gearing of the cycloid drives comprises full rolling contacts (such that the cycloid disc lobes, rollers, and input-shaft all rotate, and load is shared over a resulting greater surface area); therefore, the gearing system of such cycloid drives are on the order of 95% efficient. Knowing the input current and the efficiency of the gear set, the output torque can be more accurately predicted, and hence in certain embodiments there is no requirement for additional torque sensors within the actuator. Cycloid actuators are thus able to impart highly accurate positioning of robot links.

Cycloid drives are also particularly robust. For example, in some embodiments, a cycloid drive comprises a pair of cycloid discs that are out of phase with each other by 180° in order to balance the system, and each disc having a number of circumferential lobes as described above, are in full rolling contact with the outer-rollers of the drive such that shock-load is evenly shared over each of the lobes and the outer-rollers. In certain embodiments, with a gear set of 24 outer-rollers, and gear ratio of 24:1, the load is shared over the rolling contact surface of the 24 outer-rollers. The cycloid drive architecture is therefore highly robust in comparison to strain wave and traditional planetary gearing systems wherein the load is typically localized to one or two lobes, and hence damage prone. Thus, the architecture of cycloid drives is suitable for systems that experience high shock-loads, such as those experienced by a bipedal robot in response to a foot strike, and large torques, and further applications where positioning accuracy and performance are important.

These and other requirements have been considered in the development of a threadable cycloid actuator as disclosed and illustrated herein. In addition to providing benefits over strain wave or planetary gears as laid out above, the cycloid actuator disclosed is a threadable cycloid actuator. The threadable cycloid actuator is designed to have a through-bore tube which extends through the entire cycloid drive and through the housing of the actuator in order to provide for internal passage of critical wiring, cables, or fluid lines that may be required in order to provide communication and power, or to connect kinematic links (via joints) that are more distal in the robot kinematic chain. In some embodiments, the threadable cycloid actuator is located in a knee joint.

The threadable cycloid actuator may be positioned at any joint within the robot in order to provide pass-through capability to any distal kinematic joints and links, for example in the arms, or legs of a robot in a kinematic chain and in some preferred embodiments in the arms and legs of a bipedal robot, typically in series.

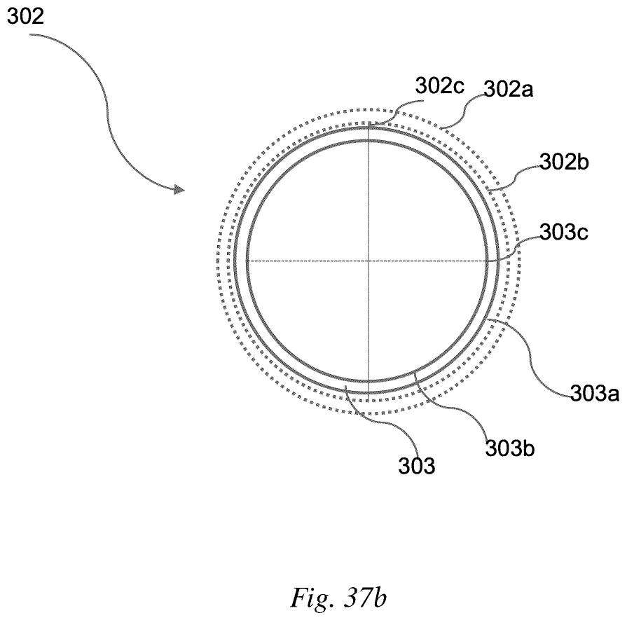

Certain embodiments of the threadable cycloid actuator and components thereof are illustrated at FIGS. 36-42.

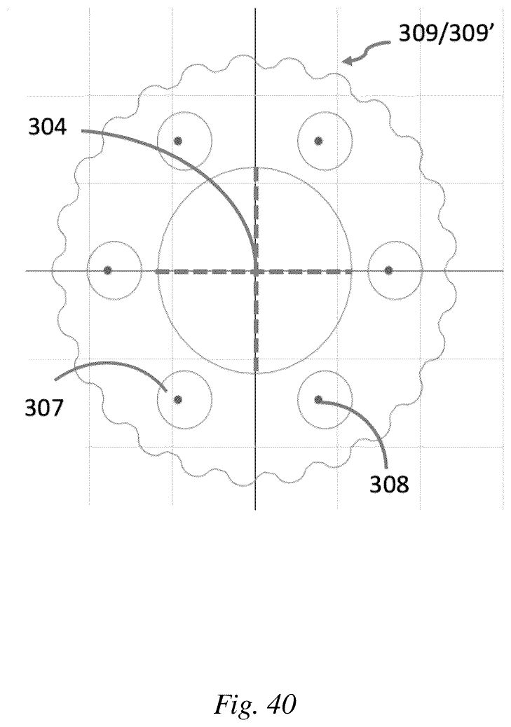

FIG. 36 is a cross sectional view of the cycloid actuator of FIGS. 38 and 39. The actuator 300 comprises a number of components, such as a cycloid drive 301 which comprises a pair of cycloid discs 309/309′, a hollow input-shaft 302 with a central throughbore tube 303, a motor 305a, a set of encoders 305b and 305c, and a housing element 305d.

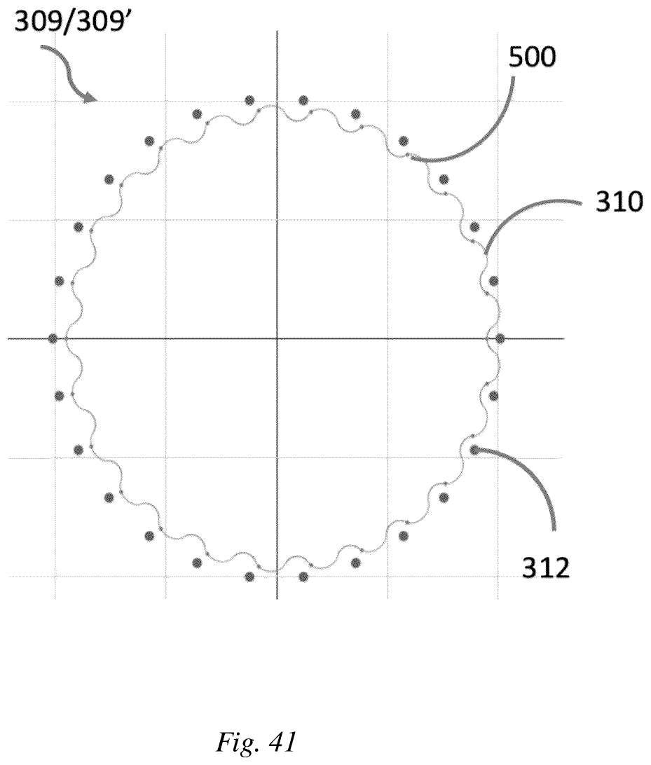

The architecture of actuator 300 has been designed in order to lower the rotational forces on the actuator components, while providing high gear ratios and improved output torque. Thus, the threadable cycloid actuator 300 is particularly configured to place the above-mentioned components and others, further from the center of rotation of the actuator as indicated by the dotted line of FIG. 36, and at FIG. 40, element 304, than in a comparable actuator without a hollow input-shaft 302 with a central through-bore tube 303. The distal placement of the components in the actuator 300 allows the hollow input-shaft 302 to have a relatively large diameter in order to receive the through-bore tube 303 which is inserted within and concentric to the hollow input-shaft.

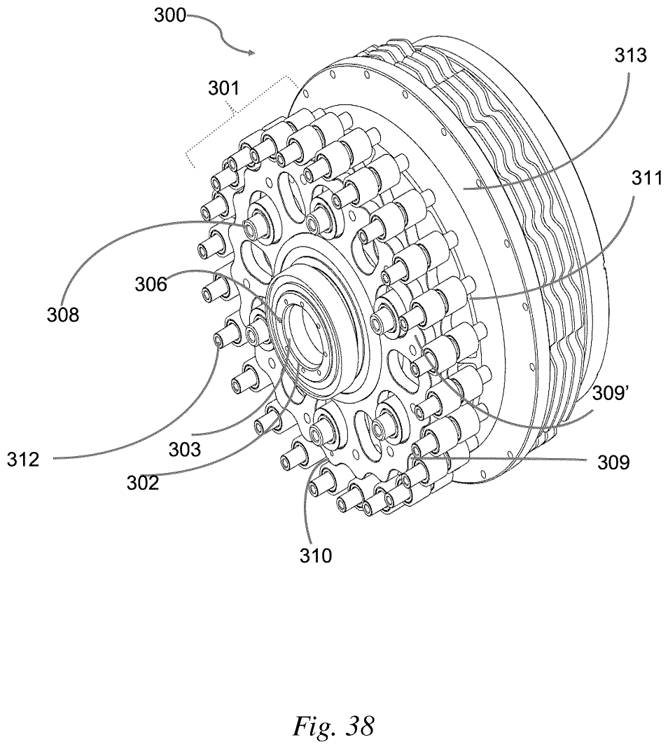

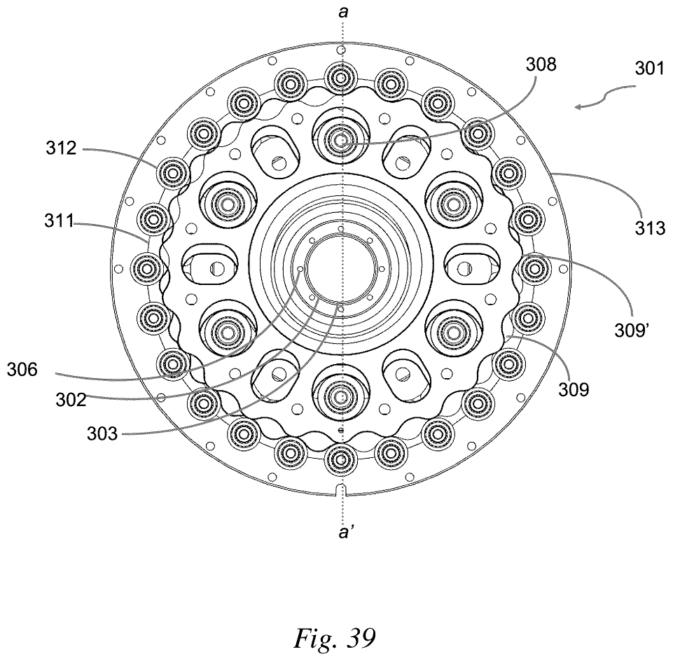

Consequently, the actuator is also more efficient, at least because the components which now reside further from the center of rotation of the actuator, experience a longer lever arm, less forces, and experience smaller loads, hence the components, including the bearings of the gearing system, require lower load ratings and are lighter, thus contributing to an overall lighter actuator with a resultant longer life-time. FIG. 37a is an exploded view of key components of an embodiment of a threadable cycloid drive assembly 301 as disclosed herein. The cycloid drive assembly has a hollow input-shaft 302 which is operatively coupled to the output shaft of a motor 305a (not shown), and has a through-bore tube 303 which is sleevingly positioned within the hollow input-shaft. The cycloid drive assembly 301 also comprises a roller bearing 306 which is eccentrically mounted to the hollow input-shaft 302, such that the roller bearing is mounted off-axis to the center of rotation of the hollow input-shaft 302.

The cycloid drive assembly 301 further comprises a mid-ring 307, wherein the mid-ring has a set of mid-ring rollers 308 arranged in a generally circular fashion on the mid-ring 307; and a pair of cycloid-discs 309, 309′, wherein each cycloid disc comprises N external lobes 310 which are located at the circumference of each disc. Each disc 309, 309′ also comprises a set of holes 314, which are evenly spaced around the center of the disc as illustrated in FIG. 37a, in order that each cycloid disc 309, 309′ can slottedly engage the set of mid-ring rollers 308. Each of the cycloid discs 309, 309′ are mounted on an associated roller bearing 306, 306′, and are thereby fixedly positioned 180° out of phase to each other. The cycloid drive assembly also comprises an outer-roller-ring 311, wherein the outer-roller-ring comprises N+1 outer-rollers 312.

In operation, the motor 305a of actuator 300 drives the hollow input-shaft 302 of the cycloid drive assembly 301 at a first input speed. The roller bearings 306, 306′, eccentrically mounted to the hollow input shaft 302, drive the cycloid discs 309, 309′ in a circular motion relative to the fixed mid-ring 307 which comprise the mid-ring rollers 307 on which the cycloid discs are mounted.

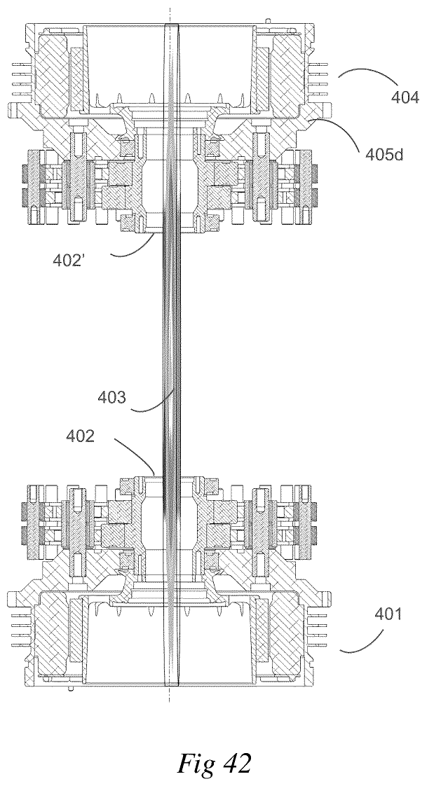

The outer-rollers 312 make contact with the N external lobes 310 of the cycloid discs 309, 309′ such that the circular motion of the cycloid discs drives the outer ring-rollers 312, and the cycloid discs 309, 309′ advance by one of the N lobes per rotational cycle of the roller bearing 306, thereby reducing the speed and increasing the torque by which the outer-ring moves relative to the speed and torque of motor and thereby providing the required gear reduction at a joint in a kinematic serial chain. Additionally, as illustrated in FIG. 42, the through-bore tube 303 receives a first element 403 at a first link or a joint in the kinematic serial chain, wherein the first element 403 traverses the through-bore tube 303, and operatively connects the first link or joint to a second link or joint in the kinematic serial chain.

A cross-sectional illustration of the hollow input-shaft 302 containing the concentric through-bore tube 303 of the cycloid drive 301 is further illustrated in FIG. 37b. The hollow input-shaft 302 comprises an exterior surface 302a, and an interior surface 302b, and the shaft has an inner diameter 302c which is preferably in the range of about 8 mm to about 16 mm. The hollow input-shaft 302 is fitted with the through-bore tube 303, the through-bore tube having an exterior surface 303a, which is adjacent to the interior surface 302b of the hollow input-shaft 302. The through-bore tube 303 also has an interior surface 303b. The through-bore tube comprises an internal diameter 303c of about 8 mm to about 16 mm. The diameter of the through-bore tube 303c is smaller than the internal diameter of the hollow input-shaft 302c allowing the throughbore tube to be slotted into, and reside within the hollow input-shaft. The through-bore tube 303 is comprised of aluminum and/or a steel alloy, and rotates at the output speed of the cycloid drive.

The through-bore tube 303 passes not only through the hollow input-shaft 302 of the cycloid drive 301 but also through the housing of the actuator 305d, and 405d as illustrated in FIG. 36 and FIG. 42 respectively. The through-bore tube 303 is therefore designed to receive an element such as a wire at an actuator located at a first joint in the kinematic serial chain of a robot arm or leg, such that the element traverses the through-bore tube and communicatively or operatively connects the first joint to a second actuator at a second joint in the kinematic serial chain, such as illustrated in FIG. 42 and discussed further below. The input-shaft 302 of the cycloid drive 301 is operatively coupled to the actuator motor 305a, and is driven at a particular input speed and torque.

The cycloid drive as also illustrated at FIGS. 38 and 39 comprises: a pair of cycloid discs 309, and 309′ such that the discs are overlapping and the lobes are out of phase by 180°, a roller bearing, which may be a pair of bearings, 306 which is eccentrically mounted to the hollow input-shaft 302, and a fixed mid-ring 307 (not visible) which has a set of mid-ring rollers 308.

FIG. 40 illustrates the position of the center of the mid-ring rollers 308, as the cycloid disc 309 or 309′, moves with a circular motion relative to the fixed mid-ring 307. The cycloid drive also has an outer-roller-ring 311, shown in FIG. 38, wherein the outer-roller-ring comprises N+1 outer-rollers 312.

FIG. 41, in a simplified form, illustrates the surface of the outer-rollers contacting at a point 500 on the circumferential lobes of a cycloid disc 309, 309′ (the second of which is not visible), such that the motion of the cycloid discs drives the outer-rollers 312, and the cycloid disc advances by one lobe per rotational cycle of the roller bearing. In some embodiments, the outer-roller-ring 311 of the drive 301 is not fixed, and the outer-roller-ring 311 is thus driven by the cycloid disc at a reduced speed and an increased torque relative to the speed at which the hollow input-shaft is driven. The output speed and torque are thus translated to a rotation of a robot link as driven by the actuator. The through-bore tube 303 also rotates at the output speed of the outer-roller-ring 311.

In some other embodiments, the cycloid drive may comprise more than two cycloid discs, wherein each cycloid-disc is out of phase relative to each other by 360° divided by the number of cycloid discs utilized in the drive. In certain embodiments of the cycloid drive 301, the mid-ring 307 is fixed to an input housing element 305d and is stationary; and in still further embodiments, the mid-ring is fixed to an output-housing element 313 which rotates at an output speed. In some embodiments the cycloid drive 301 comprises more than one roller bearing 306.

As disclosed above, a threadable cycloid actuator 300 located in a robot joint may receive a fluid line or a wiring, such that the wiring is fed through the actuator 300 and passed through to a second joint in the kinematic chain. Such an embodiment is illustrated in FIG. 42, wherein a first actuator 401 comprises a first cycloid drive with a hollow input-shaft and a first through-bore tube 402. The first through-bore tube 402 receives an element 403, such as a wire, cable, fluid line etc., and operatively connects the first actuator 401 to a second actuator 404. The second actuator 404, also comprises a cycloid drive with a hollow input-shaft and a through-bore tube 402′, through which element 403 is further threaded in order to operatively connect the first actuator 401 and the second actuator 404.

In further embodiments, the through-bore tube 402 receives an element 403 from the first actuator 401 and operatively connects the first actuator to a passive non-actuated joint. In some embodiments, a first joint comprises the first actuator 401, and a second joint comprises the second actuator 404. In some embodiments the first joint is one of a hip, knee, ankle, shoulder, wrist, or a finger joint and the second joint is one of a hip, knee, ankle, shoulder, wrist, or a finger joint, and selected as so desired. In another embodiment the first actuator 401 comprises a knee joint and the second actuator 404 comprises an ankle joint, and wherein element 403 passes within the through-bore tube 402/402′ of the actuator 401/404 and operatively connects the knee joint to the ankle joint of the kinematic serial chain.

In some embodiments, element 403 is at least one or more of: cable(s), wire(s), fluid line(s), control line(s), communication line(s) and power line(s), such that for example an cable, a wire and a control line may be threaded through the cycloid drive in order to operatively connect links in the kinematic chain. Such connections provide communication between the kinematic links. More than one element may be threaded through the same through-bore tube, forming a bundle of connective and or communication elements.

In certain embodiments of the cycloid drive 301, the through-bore tube 303 and the hollow input-shaft 302 comprises one or more of aluminum, iron, stainless steel, 7075-T6 aluminum, 6061-T6 aluminum, 416 stainless steel, 17-4 stainless steel, and 4140 alloy steel.

In some embodiments of the cycloid drive 301, the size of the diameter of the outer rollers 312 is selected so as to allow the required number of outer-rollers 312 needed for the particular gear reduction required of the cycloid drive 301. The outer-roller 312 may have a diameter of 3 mm-12 mm, and in other embodiments the outer-roller 312 has a diameter of 5-10 mm, and in some further embodiments the outer-roller has a diameter of 5, 6, 7, 8, 9, 10, 11, or 12 mm. In some embodiments, the outer-roller 312 comprises an outer-roller pitch circle, wherein the outer-roller pitch circle has a diameter of about 10 mm to about 150 mm, and in other embodiments the outer-roller pitch circle has a diameter of about 30 mm to about 120 mm. The diameter of the outer roller 312, and the diameter of the outer-roller pitch circle may be of any size suitable for performing a function as disclosed herein.

In some embodiments of the cycloid drive 301, the set of mid-ring rollers 308 comprises between 6 and 12 rollers, in another embodiment the set of mid-ring rollers comprises 6 rollers, and in a further embodiment the set of mid-ring rollers comprises 8 rollers. In certain embodiments of the cycloid drive 301 the mid-roller 308 has a diameter of 5 mm to 20 mm, and in other embodiments the mid-roller has a diameter of about 10 mm to about 16 mm. The diameter of the mid ring roller may be of any size suitable for performing a function as disclosed herein.

In a further embodiment, the mid-roller 308 comprises an mid-roller pitch circle, wherein the mid-roller pitch circle has a diameter of 10 mm-100 mm, and in a still further embodiment the mid-roller comprises an mid-roller pitch circle, wherein the mid-roller pitch circle has a diameter of about 30 mm to about 80 mm. The mid-roller pitch circle may be of any size suitable for performing a function as disclosed herein. The size and shape of the cycloid discs 309/309′ are in some embodiments therefore determined in part by the radius of outer-roller-ring 311, the radius of the outer-rollers 312, the number of the outer-rollers 312, and the eccentricity of the roller bearing 306.

In a certain embodiment of the cycloid drive 301, the drive assembly is designed to have a gear ratio of between 16:1 and 30:1. The circumference of the outer-roller-ring 311 is therefore in part dependent on the size and number of the individual outer-rollers 312 that comprise the outer-roller-ring. In a preferred embodiment the gear ratio is 24:1, such that there are 24 outer-ring rollers 312, the size of the outer-roller-ring 311 and the subsequent elements of the cycloid drive therefore provides the required radial space within the cycloid drive to accommodate a preferred embodiment of the through-bore tube 302 of a diameter 303c as disclosed herein.

The cycloid drive 301 was designed to provide a gear ratio of more than 16:1, such that gear ratios provided are: 18:1; 20:1; 22:1; 24:1; 26:1; 28:1; 30:1 and upwards, when two cycloid discs 309,309′ are utilized. In other embodiments, a gear set may comprise other numbers of cycloid drives (1, 3, 4, 5 etc.) such that the gear ratio may be configured to be 17:1; 18:1; 19:1; 20:1; 21:1; 22:1; 23:1; 24:1; 25:1; 26:1; 27:1; 28:1; 29:1; 30:1 and upwards. Thus, reduction ratios are achieved by selecting the number of outer-rollers 312 on the outer-roller-ring 311 to be driven by the motion of the cycloid discs 309/309′ at an output speed that is lower than the input speed, and a torque that is greater than the input torque of the hollow input-shaft 302 that is driven by the motor 305a of the actuator. The number of outer rollers 312 and subsequent gear ratio also in part defines the achievable diameter of the hollow input-shaft 302 and the through-bore tube 303 which is concentric to the hollow input-shaft and threaded or sleeved within the hollow input shaft, and it is therefore the arrangement of the outer-rollers 312 in part defines the size of the diameter of the through-bore tube 303.

In a certain embodiment of the cycloid drive 301, the hollow input-shaft 302 has an input eccentricity of 0.5 mm to 3 mm, in another embodiment the input-shaft 302 has an input eccentricity 0.75 mm to 2.5 mm, and in a further embodiment the input-shaft has an input eccentricity of about 1 mm to about 2 mm. The input eccentricity may be modified to any further size suitable for performing a function as disclosed herein.

In some embodiments of the cycloid drive 301, the roller bearing 306 has an outside diameter of between 20 mm-60 mm, in another embodiment the roller bearing 306 has an inside diameter of between 15 mm-40 mm, and in a further embodiment the roller bearing 306 has an inside diameter of between 8 mm-40 mm. The roller bearing 306 may be of any size suitable for performing a function as disclosed herein.

In a particular embodiment, a cycloid drive assembly 302 with a through-bore tube 303 is disclosed. The cycloid drive assembly comprises: a roller bearing 306 eccentrically mounted to a hollow input-shaft 302 which is concentric to the throughbore tube 303, and the input-shaft is operatively coupled to receive torque from a motor 305a. The cycloid drive 301 also comprises a mid-ring 307, wherein the mid-ring comprises a set of mid-ring rollers 308 and is fixed to an stationary housing element 305d; a pair of cycloid-discs 309/309′, such that each cycloid-disc comprises N external lobes 310, wherein each cycloid-disc is positioned onto the set of mid-ring rollers 308, and each cycloid-disc is out of phase by 180° relative to each other, and wherein each cycloid-disc comprises a wobble-motion produced by the roller bearing 306 eccentrically mounted to the input-shaft; and an outer-roller-ring 311, wherein the outer-roller-ring comprises N+1 rollers 312, wherein the rollers are engaged by the N external lobes of each cycloid-disc, and the wobble-motion drives the outer-roller-ring 311 with a reduced speed and an increased torque relative to the speed and torque received from the motor 305a, such that the outer-roller-ring is fixably connected to a driven link.

Disclosed herein, in another particular embodiment is a threadable cycloid actuator 300 for the purpose of operatively connecting links in a kinematic serial chain. The actuator comprises: a housing, wherein the housing comprises a stationary housing element 305d, and an output housing element 313; a motor 305a; an input encoder 305b; an output encoder 305c; and a cycloid drive 301. The cycloid drive 301 (which in some embodiments may be referred to as a cycloid drive assembly and thus the terms are interchangeable as used herein) comprises: a hollow input-shaft 302 with an internal diameter 302c, and a through-bore tube 303, 402, 402′ of a internal diameter 303c, wherein the through-bore tube is concentric to the input-shaft. The throughbore tube receives a first element 403 at a first joint in the kinematic serial chain, wherein the first element 403 traverses the through-bore tube and operatively connects the first joint to a second joint in the kinematic serial chain. As illustrated in FIG. 42, the actuator may be a first actuator 401, that is connected to a second actuator 404, such as by a wire, fluid line, a cable, or a bundle thereof 403, and as discussed above is passed through the first actuator in order to operatively or communicatively connect two joints in series. The second joint in series may however not comprise an actuator, being passive and not driven.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Any reference herein to “the inventors” means at least one inventor of the present technology. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. interactions, etc.

Directional terms, such as “upper,” “lower,” “front,” “back,” “vertical,” and “horizontal,” may be used herein to express and clarify the relationship between various structures. It should be understood that such terms do not denote absolute orientation. The term “centroid” as used herein refers to a center-like data element for a given shape in three-dimensional space. There are several known approaches to calculating centroids including approaches of greater and lesser precision. No particular approach is contemplated herein. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

1. A threadable cycloid drive assembly comprising:
a hollow input-shaft having an exterior surface;
a through-bore tube sleevingly disposed within the hollow input-shaft;
at least one roller bearing mounted on the exterior surface of the input shaft;
at least two cycloid discs mounted on the at least one bearing, each of the discs having an outer edge forming N external lobes and a body formed with a circular arrangement of slots;
a mid-ring comprising a set of mid-ring rollers that extend away from the mid-ring to engage the slots; and
an outer roller-ring comprising a housing and N+1 outer-rollers that engage with the external lobes of the discs;
wherein the through-bore tube receives a first element at a first link in a kinematic chain, and wherein the first element traverses the through-bore tube and operatively connects the first link to a second link in the kinematic serial chain.

2. The threadable cycloid drive assembly of claim 1, wherein the cycloid drive is operatively coupled to an actuator.

3. The threadable cycloid drive assembly of claim 1, wherein the first link and the second link each comprise an actuated joint.

4. The threadable cycloid drive assembly of claim 1, wherein one or more of the first link and the second link comprises a passive joint.

5. The threadable cycloid drive assembly of claim 1, wherein the first link comprises a knee joint and the second link comprises an ankle joint, and wherein the first element is centrally positioned within the through-bore tube and operatively connects the knee joint to the angle joint of the kinematic serial chain.

5. (canceled)

6. The threadable cycloid drive assembly of claim 1, wherein an output is operably connected to one of the mid-ring and the outer roller-ring housing.

7. The threadable cycloid drive assembly of claim 1, wherein the outer-roller-ring of the drive is fixably connected to a driven link.

8. The threadable cycloid drive assembly of claim 1, wherein the mid-ring is either fixed to an input housing element of an actuator and is stationary or the mid-ring is fixed to an output-housing element of an actuator and rotates at an output speed.

9. The threadable cycloid drive assembly of claim 1, wherein each cycloid-disc is out of phase relative to each other by 360° divided by the number of cycloid discs utilized in the drive.

10. The threadable cycloid drive assembly of claim 1, wherein the drive has a gear ratio of between 18:1 and 30:1.

11. The threadable cycloid drive assembly of claim 1, wherein said first element is at least one or more of: cable(s), fluid line(s), control line(s), communication line(s) and power line(s).

12. The threadable cycloid drive assembly of claim 1, wherein the throughbore tube enables power, control, and communication lines to pass through the threadable cycloid drive assembly to support other actuators in the kinematic chain.

13. The threadable cycloid drive assembly of claim 1, wherein the diameter of the through-bore tube is between 8 mm and 16 mm.

14. A threadable actuator, for the purpose of operatively connecting links in a kinematic serial chain, said actuator comprising:
a housing, wherein the housing comprises:
a stationary housing element, and
an output housing element;
a motor, having a hollow output shaft;
an input encoder;
an output encoder; and
a cycloid drive assembly, wherein the cycloid drive assembly comprises:
a hollow input-shaft having an exterior surface;
a through-bore tube sleevingly disposed within the hollow input-shaft;
at least one roller bearing mounted on the exterior surface of the input shaft;
at least two cycloid discs mounted on the at least one bearing, each of the discs having an outer edge forming N external lobes and a body formed with a circular arrangement of slots;
a mid-ring comprising a set of mid-ring rollers that extend away from the mid-ring to engage the slots;
an outer roller-ring comprising a housing and N+1 outer-rollers that engage with the external lobes of the discs; and whereby the threadable actuator enables power, control, and communication lines to pass through it to support links in the kinematic chain.

15. The threadable actuator of claim 14, wherein the hollow input shaft is operatively coupled to an output shaft of the motor.

16. The threadable actuator of claim 14, wherein an output is operably connected to one of the mid-ring and the outer roller-ring housing.

17. The threadable actuator of claim 14, wherein the outer-roller-ring of the drive is fixably connected to a driven link.

18. A robot leg, comprising:
at least two links, wherein the links each comprise a joint, and wherein the joint(s) are operatively connected by at least one of power, control and communication lines, wherein the lines pass through the first joint at a first cycloid drive assembly to a second cycloid assembly in a second joint, wherein each cycloid drive assembly is threadable and comprises:
a hollow input-shaft having an exterior surface;
a through-bore tube sleevingly disposed within the hollow input-shaft;
at least one roller bearing mounted on the exterior surface of the input shaft;
at least two cycloid discs mounted on the at least one bearing, each of the discs having an outer edge forming N external lobes and a body formed with a circular arrangement of slots;
a mid-ring comprising a set of mid-ring rollers that extend away from the mid-ring to engage the slots; and
an outer roller-ring comprising a housing and N+1 outer-rollers that engage with the external lobes of the discs; wherein the through-bore of the cycloid drive assembly enables the power, control, and communication lines to pass through the cycloid drive assembly to support joints in the robot leg.

19. The robot leg of claim 1, wherein the first joint is a knee joint and the second joint an ankle joint.

20. The robot leg of claim 1, wherein the first joint is a knee joint and the second joint is a hip joint.
